(19) United States
(12) Patent Application Publication
(10) Pub. No.: US 2009/0103989 A1
(43) Pub. Date: Apr. 23, 2009

(54) Method of dynamic energy-saving superconductive transporting of medium flow

(75) Inventors: Arkadi Relin, Langhorne, PA (US); Ion Marta, Philadelphia, PA (US)

Correspondence Address: Arkadi Relin, 12 Woodbridge Place, Langhorne, PA, 19053, US

(73) Assignee: REMCO International , Inc., Huntingdon Valley, PA (US)

(21) Appl. No.: 12/287,771

(22) Filed: Oct. 15, 2008

Related U.S. Application Data
(60) Provisional application No. 61/137,106, filed on Jul. 28, 2008.
(60) Provisional application No. 61/069,329, filed on Mar. 14, 2008.
(60) Provisional application No. 61/065,250, filed on Feb. 11, 2008.
(60) Provisional application No. 61/006,148, filed on Dec. 26, 2007.
(60) Provisional application No. 61/007,628, filed on Dec. 14, 2007.
(60) Provisional application No. 60/999,107, filed on Oct. 17, 2007.

(51) Int. Cl. B65G 53/00

(52) U.S. Cl. 406/12

(57) ABSTRACT

In a transporting system comprising at least one a means of medium flow-forming energy action for providing a dynamic energy-saving superconductive medium flow process, a method of energy optimizing includes a negative modulating of the energy action with a frequency is changed to provide a plane form of a modulated energy action flow longitudinal waves, a law is selected a “drop-shaped” form, a comparative phase is changed to provide a phase shift to a comparative phase of an independent periodic process related with a modulated flow; and energy criterion optimized changing a modulation parameters in dependence on a changes of a flow process characteristics.

### TECHNICAL FIELD

The present invention relates to methods and devices, which provide transporting of an object with a flow of a carrying medium. It encompasses a broad class of various systems which are used, for example: in industry; in energy-related systems; in pipelines, ground, air, above water, underwater, and other types of transportation; in medical and household technique; in converting and special technique; in special destructive and explosive technique; in research devices and systems; in physiological systems and in other areas. In the present time the broad class of such systems under consideration represents one of important developing areas in the world, characterized with significant energy consumption.

### BACKGROUND ART

Various methods and devices are known, which provide transporting of objects with a flow of a carrying medium. A common traditional methodological approach, which is used in various systems in the above-mentioned class is application of an action to the above-mentioned carrying medium from an action means, which creates during the process of conversion of the energy supplied to it, and integrally constant in time action so that the above-mentioned flow of the carrying medium created in this way acts on the above-mentioned object for providing the process of its transporting in a given direction. This approach is realized in various systems, which use mainly two types of means for action: means of pressure drop (pumps; screw, turbine, turbo reactive and reactive systems; explosive devices of pumping or vacuum action; means of action, which use a forced aerodynamic or hydrodynamic interaction of the object or its structural part, correspondingly with gaseous or liquid medium, for example a region of an outer surface of a casing of a flying, speedy ground or underwater moving apparatus, etc.), and means for direct energy action (magneto and electro hydrodynamic pumps; magnetic and electromagnetic acceleration systems, etc.). The object can be structurally not connected or structurally connected (for example in a flying apparatus) with the action means. In some cases the object, being a flowable medium, performs a function of the carrying medium (for example gas or liquid product such as oil transported in a pipeline). In various known action means, energy which is supplied to them and is converted in them can be of various types, such as for example: electrical, electromagnetic, magnetic, mechanical, thermal energy; energy generated for example as a result of performing correspondingly: a chemical reaction, a nuclear reaction, a laser action, etc., or for example energy generated during operation of a physiological system; or generated during a forced aerodynamic interaction of an object with a gaseous medium or during a forced hydrodynamic interaction of an object with a liquid medium. In some known action means, as the supplied energy a combination of several different types of supplied energy is utilized (for example, a combination of magnetic and electrical energy as in a magneto and electro hydrodynamic pumps). As the carrying medium, mainly a flowing (gaseous or liquid) medium is utilized. The object of transportation can be for example: powder or granular material; gaseous or liquid medium; excavated product (coal, ore, oil, gas, gravel, etc.); a mixture of materials and media; a component or refuse of manufacturing process; fast movable or immovable objects; physiological or physical substance; and many others.

Common disadvantages of the known traditional methodological approach, which is realized in such systems for providing of a process of transporting an object with a flow of a carrying medium, are as follows:
limited possibilities for reduction of specific consumption of energy for providing the process of transporting of the objects;
impossibility of performing efficient dynamic control of the process of transporting, with the purpose of optimization of its energy characteristics;
presence of negative side effects which accompany work of some of such systems and significantly worsen their operational and energy characteristics (for example “sticking” during suction; adhesion of particles on the inner walls or clogging of a portion of a channel which limits the transported flow; a fast clogging of the filtering devices, which operate in a multi-phase flow; and so on).

The above-listed disadvantages significantly reduce energy, and therefore also economical efficiency of application of such traditional systems for providing the process of transporting an object unit by a flow of a carrying medium.

Other methods and devices for dynamic transporting of an object with a flow of a carrying medium are known, as disclosed for example in U.S. Pat. No. 5,201,877 (1993); U.S. Pat. No. 5,593,252 (1997); and U.S. Pat. No. 5,865,568 (1999)—A. Relin, et al. The above-mentioned methods and devices realize a methodological approach, which was first proposed by Dr. A. Relin in 1990 and utilizes a negative modulating of the suction force, performed outside of the action means by connection of an inner cavity of the suction area of the transporting line with atmosphere through a through going passage and simultaneous periodic change of an area and shape of the through going passage during transporting of the object. The use of this approach, (which is named by Dr. A. Relin “AM-method”), which realizes the “Principle of controlled exterior dynamic shunting” of the suction portion proposed by the author opens qualitatively new possibilities for significant increase of efficiency of operation and exploitation of a certain class of devices and systems for suction transporting of various objects. In particular, uses a negative modulating of the suction force over a limited suction portion of movement of the flow in a closed passage, for example in vacuum cleaning systems, in various medical suction instruments, and also in pneumo transporting systems of various materials and objects allows to minimize and even completely eliminate the above-mentioned common disadvantages which are inherent to known traditional approach realized in the known systems of this type.

However, the necessity and possibility of performing the connection of the interior cavity of only the suction portion of the transporting line (outside of the above-mentioned action means) with the atmosphere through the through going passage does not allow to use this principle of modulation in a sufficiently broad class of other types of known devices and systems which can provide a process of transporting an object with the flow of a carrying medium:
which do not allow a contact with atmospheric medium of the object transported in the closed passage, for example various gasses, chemical and physiological materials and media;
which do not allow an entraining of atmospheric medium (for example air) into the hydro transporting system which can lead to cavitations effects damaging of the pipeline and the hydraulic pump, and also additional energy losses in the process of transporting an object with a flow of a carrying medium;
which do not allow a possibility of performing the connection of the inner cavity of the pumping line of transportation with atmosphere through the throughgoing passage, causing expelling of the transporting medium into atmosphere;
which provide identical speed characteristics over the whole extension of the movable flow: both at its suction portion and its pumping portion;
which do not allow a possibility of realization of such approach due to absence of a closed long suction portion of the passage during the use of various types of above-mentioned action means on the carrying medium with a pressure drop, for example: connected with the object of transporting—screw, turbine, turbo reactive and reactive systems; various explosive devices; action means, which use forced aerodynamic and hydrodynamic action of the object, correspondingly, with gaseous and liquid medium; and other similar types of action means;
which do not provide a pressure drop with the action means used in them, realizing other principles of performing of the above-mentioned action, for example during the use of the above-mentioned means of direct energy action.

In addition, during the development of the construction of the modulator which realizes the above-mentioned “Principle of controlled exterior dynamic shunting” of the suction portion it is necessary to solve additional problems, for example: connected with a reduction of the level of additional noise effect caused during a periodic connection of the atmospheric medium with the internal cavity of the suction portion of the transporting line; and also effects connected with protection of the throughgoing passage of connection of the modulator from possible sucking into it of various components of an exterior medium or foreign objects.

The attempts to take into consideration these factors in such cases additionally complicate and make more expensive the construction and the operation of the modulator.

The above-explained disadvantages significantly limit the possibilities during solution of real problems connected with energy optimization of processes of transporting of an object with a flow of a carrying medium, and also areas of application of the above analyzed efficient methodological approach, which uses the negative modulation of the suction force over the suction portion, performed with the use of the above-mentioned “Principle of controlled exterior dynamic shunting”.

Other method and devices for dynamic transporting of an object with a flow of a carrying medium are known, as disclosed for example in U.S. Pat. No. 6,827,528 (2004)—A. Relin. The principle new method (which is named by the inventor “R-method”) is based on works of Dr. A. Relin and confirmed by scientific research of concepts of a new theory “Modulating aero- and hydrodynamics of processes of transporting objects with a flow of a carrying medium”. This scientific concepts consider new laws which are developed by the author and connected with a significant reduction of a complex of various known components of energy losses (and therefore of specific consumption of energy) during creation of a dynamically controlled process of movement of the flow of a carrying medium with a given dynamic periodically changing sign-alternating acceleration during the process of transporting of the above-mentioned object.

The dynamic method minimizes or completely eliminates the above-mentioned disadvantages in providing an efficient process of transporting of an object with a flow of a carrying medium which are inherent to the known traditional methodological approach and the above-mentioned second approach, which uses the negative modulation of suction force based on the “Principle of controlled exterior dynamic shunting” of the suction portion. High-energy efficiency of said dynamic method is obtained due to the fact that it solves a few main problems:
it provides minimization of negative dominating influence of turbulence on losses of kinetic component of the applied energy in a zone of a boundary layer and in a nucleus of the flow of a carrying medium during of providing the process of transporting of an object;
it provides minimization of various components of energy losses connected with the process of transporting of the object itself by the flow of a carrying medium during whole period of this process;
it provides possibility of a given multi-parameter dynamic control of the process of transporting of an object with a flow of a carrying medium during its whole realization;
it provides possibility of significant reduction of integral value of energy action applied to the above-mentioned flow and as a result, provides practically analogous significant reduction of consumption of the supplied energy which is converted (consumed) by the action means to the flow;
it provides possibility of dynamic consideration of characteristics (criteria) of the process of transporting of an object with the flow of carrying medium for optimization of the given multi-parameter dynamic control by executing this process with the purpose of increasing of its energy efficiency.

The method of dynamic transporting of an object with a flow of a carrying medium includes the following steps:

In a conveyor, comprising a cyclic drive means transporting a fluid medium having at least one object entrained therein through an enclosed passage, said drive means interposed between upstream and downstream segments of said passage and comprising a first working zone in a negative drive cycle and a second working zone in a positive drive cycle; a method of optimizing at least one value of said object entrained fluid medium characteristic of said transporting of said object entrained fluid medium with respect to drive means energy consumption comprising: providing at least one shunt passage from said second working zone to said first working zone; flowing said object entrained fluid medium through said shunt passage from said second working zone to said first working zone thereby changing said at least one value of said object entrained fluid medium and the difference in magnitude between said cycles; modulating the flow through said shunt passage to optimize said at least one a value with respect to drive means energy consumption.

As the above-mentioned cyclic drive means (or action means), either a means of pressure drop or a means of direct energy action can be utilized. The method embraces all possible spatial conditions of the transporting object. In some cases the object can be a flowable medium and in this case can perform a function of the above-mentioned carrying medium. In other cases the object can be structurally not connected or structurally connected with the action means in the process of its transporting. In certain situations the structural part of the object can perform the function of a converting element of the action means so as to provide the process of conversion of energy supplied to it and generated during forced interaction of this structural part of the object with the flowable medium.

Another important feature of said invention is that the above-mentioned given modulation of the value of the action in the action means is performed by providing a given dynamic periodic change of the value of a parameter which is dynamically connected with the process of conversion of the action means of the energy supplied to it into the action with simultaneous given change of the value of this parameter in each period of its change during the process of transporting of the object. This approach can be used both in the case of utilization of the pressure drop action means and in the case of utilization of the direct energy action means.

As the parameters of the process of conversion of the supplied energy following, for example: electrical, electromagnetic, magnetic, structural, technical, physical, chemical or physic-chemical parameter; or a combination of various types of these parameters, can be utilized. As the energy supplied to the action means, the following energy for example can be used: electrical, electromagnetic, magnetic, mechanical, thermal energy; energy generated as a result of performing of chemical or nuclear reactions; energy generated during the operation of a physical system; energy of forced aerodynamic interaction of a structural part of the object with a gaseous medium (performing the function of the action means); energy of forced hydrodynamic interaction of the structural part of the object with liquid medium (performing the function of the action means); or it can use a combination of several types of the supplied energy.

In accordance with another feature of said invention, the given modulation of the value of the action in the pressure drop means is performed by providing a simultaneous given dynamic periodic change in working zones of the pressure drop means, correspondingly, of a value of a negative over pressure and a value of a positive over pressure with a simultaneous their change in each period of the change of the above-mentioned values of the above mentioned actions, generated in the process of conversion of the energy supplied to the pressure drop means in the working zones, which are in contact with the carrying medium, so as to provide application of the generated given dynamic periodic action determined by the above-mentioned values of the negative and positive over pressures during the process of transporting of the object.

The simultaneous given dynamic periodic change in the working zones of the pressure drop means, and correspondingly of the value of negative over pressure and the value of positive over pressure with simultaneous their change in each period of the change of the values of the pressures is performed by a given dynamic periodic change of the value of connection between the working zones with a simultaneous given change of the value of the connection in each its period during the process of transporting of the object.

At the same time, the given dynamic periodic change of the value of connection of the working zone with the simultaneous given change of the value of the connection in each its period is performed by a given dynamic periodic generation on a portion of a border of separation between the working zones of a throughgoing passage (or several passages) with a simultaneous given change of the value of a given area of a minimal cross-section of the passage (or several passages) in each period of the generation, accompanied by performing correspondingly of a given dynamic periodic local destruction and subsequent reconstruction of the portion of the border with a simultaneous given change of the value of area of its local destruction in each period during the process of transporting of the object. The above-mentioned local destruction is performed by destruction means, for example: technical, physical, chemical, physic-chemical; or is performed by a combination of several types of the destruction means. The portion of the border of separation between the working zones can be identified either structurally or spatially.

In some cases of utilization of the new method, in a process of the given dynamic periodic generation on a portion of the border of separation between the working zones of the throughgoing passage (or several passages) with simultaneous given change of the value of the given area of a minimal throughgoing cross-section of the passage (or several passages) in each period of its action, a filtration of local volume of the carrying medium which in a zone of the given throughgoing passage during the process of the transporting of the object is performed.

The above-mentioned new features of said invention reflect a new “Principle of controlled interior dynamic shunting” of working zones of the pressure drop means. In accordance with the important features of said invention, in said method for performing the given modulation of the value of the action in the action means, values of its parameters are given: frequency, range and law of dynamic periodic change of the value of the action during the process of transporting of the object. The method makes possible a realization of one of several main variants of giving of the values of the parameters:
the given values of parameters of modulation do not change during the process of transporting;
the values of one (or several) of the given parameters of the modulation is or are changed in a given dependency from changes of a controlled characteristic connected with the process of transporting of the object;
the values of the changing parameters of the given modulation are changed in a given dependency from changes of a combination of several types of the control characteristics connected with the process of transporting of the object.

The process provides a possibility to use as the control characteristic, without any limitation, for example as follows:
value of one of the parameters of the process of transporting of the object (energy consumption, optimized specific consumption energy or speed parameter);
values of one of parameters of the transporting object (speed, consumption, aerodynamic, hydrodynamic, structural, physical, amplitude-frequency, chemical or geometric parameter);
values of one of parameters of spatial position of the object during the process of transporting;
values of one of parameters of a surface of a position of the object during the process of transporting (for example physic-mechanical);
values of one of parameters of the flow of the carrying medium during the process of transporting of the object (for example speed, structural, physical or chemical parameter);
values of one of parameters of a turbulent process in the flow of carrying medium during the process of transporting of the object (for example amplitude, frequency or energy parameter);
value of one of parameters of a process of conversion of energy of movement of the flow of carrying medium into another type of energy (during interaction or without interaction with an additional source of energy, which acts on the flow) during the process of transporting of the object.

For the first time, the proposed by authors the functional classification of the methods of minimization of hydrodynamic resistance of turbulent medium flow (proposed at the past 100 years) allowed to divide them in the four groups. Herewith, the analysis of methods of minimization of hydrodynamic resistance was made taking into consideration the particularities of types of actions on the turbulent flow structure and turbulent boundary layer.

The first group includes the methods of mechanical constructive—parameters perturbing of medium flow. Said methods use the changes of interior surface of the pipe, for example:
the method of mechanical constructive—geometric perturbing of medium flow (for example, the turbulators installed on the interior surface of the pipe for the local perturbations of turbulent boundary layer—Germany, 1904);
the method of mechanical constructive—surface perturbing of medium flow (for example, the polymer coating installed on the interior surface of the pipe for the diminution of friction tension USA, 1916).

The general shortcomings of the indicated first group of methods are following: the perturbing action on the local part of the flow; the impossibility of automatic control of action on the process for changing a technological parameters of medium flow; the limited applied possibilities from the constructive point of view; the costliness of technical realization; the possibility of chemical reactions between polymer coating and different flow medium; and etc.

The second group includes methods of Theological parameters changing of medium flow. Said methods use the injection of the addition liquid polymers in the medium flow, for example:
the method of local polymer—dose rheological changing of medium flow (for example, the small quantity of liquid polymers with long and heavy molecules injected in the medium flow for the diminution of medium viscosity—Netherlands, 1948).

The general shortcomings of the indicated second group of methods are following: the changes of chemical composition of flow medium; can be used only for the limited types of flows, which allows pollution; and etc.

The third group includes the methods of mechanical local periodical perturbing of medium flow. Said methods use the different types of local periodical perturbing energy action of the medium flow, for example:
the method of mechanical local—streamwise periodical perturbing of medium flow (for example, the small local perturbing provided by the wall channel or pipe portion periodical streamwise oscillations—England, 1963);
the method of mechanical local—spanwise periodical perturbing of medium flow (for example, the small local perturbing provided by the channel element or pipe around its axes periodical spanwise oscillations—England, 1986);
the method of mechanical local—rotate periodical perturbing of medium flow (for example, the small local rotational perturbing provided by the rotation of pipe around its axes‘USA, 1988);
the method of mechanical local—radial periodical perturbing of medium flow (for example, the small local perturbing provided by the mechanical radial periodical pressure spreading along the whole cross section of the pipe—Denmark, 1997).

The general shortcomings of the indicated third group of methods are following: the small local perturbing; the consumption of the additional energy; the constructive complications of practical realization; the limited area of applications; and etc.

As have been shown the multi-years researches by the authors (in company “Remco International, Inc.”, PA, USA) the above-mentioned fundamentally new (the fourth group) methods of dynamic transporting of an object with a flow of a carrying medium (USA, 1990 and 2004) do not have the practical analogs in the history of development of hydrodynamics and on the real possibilities of decreasing of hydrodynamic resistance of the turbulent flows. Said dynamic energy-saving methods (on the complex of fourteen analyzed basic constructional, energy, operational and economic criteria) at the several orders exceed all of the above-mentioned researched methods of decreasing of hydrodynamic resistance of the turbulent medium flows. A wide efficient practical application of the new (modulation) methods will open the qualitatively new real possibilities of decreasing (on the tens percents) of hydrodynamic resistance of the turbulent flows.

Therefore, the future search of the scientifically-justified ways of the energy optimize of said dynamic energy-saving methods is foreground for the accelerated practical development of modulating of aero- and hydrodynamic processes of superconductive transporting of objects with a flow of a carrying medium.

### SUMMARY OF THE INVENTION

Accordingly, it is an object of the present invention to provide a new method of dynamic energy-saving superconductive transporting of medium flow, which is based on new modulation principles.

The proposed method is based on the results of multi-years scientific research works of Dr. A. Relin and Dr. I. Marta, developing of the concepts of above-mentioned new theory “Modulating aero- and hydrodynamics of processes of transporting objects with a flow of a carrying medium”. Said scientific researches posited the goals, connected with the solutions of series of the basis principle new scientific-practical problems:
the establishment of scientifically-founded law of said negative modulating, providing the most energy efficiency of process of the introduction in the flow of modulated medium flow-forming energy action and one correlation connecting the others general predetermined modulation parameters (a frequency and a range);
the establishment of the scientifically-founded range for choice of a frequency of said negative modulating, providing the most energy efficiency of the wave process of introduction in the flow of modulated medium flow-forming energy action;
the establishment of the scientifically-founded criterion of the energy optimization of said negative modulating a value of medium flow-forming energy action to realize said new method of dynamic energy-saving superconductive transporting of medium flow;
the establishment of the scientifically-founded new additional time parameter of said negative modulating, providing the most of energy efficiency of process of the introduction in the flow of modulated medium flow-forming energy action, when said modulated medium flow related with at least one an independent predetermined periodic process;
the establishment of the scientifically-founded zone to realize the dynamic efficient wave process of the dynamic connection under the technical realization of the above-mentioned “Principle of controlled interior dynamic shunting” of a suction and a power working zones of a means of medium flow-forming energy action or the above-mentioned “Principle of controlled exterior dynamic shunting”.

For the first time these scientific researches allowed to propose the new most energy-effective principles of the realization of said negative modulating a value of a medium flow-forming energy action for realizing of said new method of dynamic energy-saving superconductive transporting of medium flow.

In keeping with these objects and with others, which will become apparent hereinafter, one of the new features of the present invention resides, briefly stated, in a new method of dynamic energy-saving superconductive transporting of medium flow, which includes the following.

In a dynamic medium flow control transporting system for providing a dynamic medium flow process, comprising at least one a means of medium flow-forming energy action; a method of energy optimizing comprising the steps of:
negative modulating a value of said medium flow-forming energy action includes providing a frequency, a range and a law as a general predetermined modulation parameters;
a value of said predetermined frequency is changed to provide a plane form of a modulated medium flow-forming energy action waves spreading lengthwise of a longitudinal axis of said modulated medium flow;
said modulating includes providing a comparative phase as an additional predetermined modulation parameter, when said modulated medium flow related with at least one an independent predetermined periodic process; and
providing a minimal value of energy ratio of a controlled in action value of said modulated medium flow-forming energy into a controlled in action value of a formed kinetic energy of said modulated medium flow during said dynamic medium flow process by changing a value of at least one said modulation parameter in dependence on a change of a value of at least one a characteristic connected with said dynamic medium flow process to dynamic structure-energetically optimize, in an energy-effective manner, said dynamic medium flow process.

As the above-mentioned means of medium flow-forming energy action, either a means of pressure drop or a means of direct energy action can be utilized. The proposed method embraces all possible spatial conditions of the flow-transporting object. In some cases the object can be a flowable medium and in this case can perform a function of a carrying medium. In other cases the object can be structurally not connected or structurally connected with the action means in the process of its flow-transporting. In certain situations the structural part of the object can perform the function of a converting element of the action means so as to provide the process of conversion of energy supplied to it and generated during forced interaction of this structural part of the object with the flowable medium.

Another important feature of the present invention is that the above-mentioned said predetermined law of said negative modulating a value of said medium flow-forming energy action is the “drop-shaped” form selected.

The above-mentioned predetermined “drop-shaped” form of said law of said negative modulating (which is named by authors—“drop-shaped modulating law of Relin-Marta”) includes providing decrease of a value of said medium flow-forming energy action from a current maximal value on a predetermined value of range of said modulating during a predetermined front time of realizing a predetermined front short part of said “drop-shaped” form of said law, and providing recovery of a value of said medium flow-forming energy action until said current maximal value during a predetermined back time of realizing a predetermined back extended part said “drop-shaped” form of said law during an each predetermined period of said negative modulating is changed to provide a predetermined period and frequency of said modulating.

At the same time the predetermined front short part of “drop-shaped” form of said modulation law is changed a form of a predetermined quarter ellipse curve such that a horizontal axis of said ellipse coincides with a horizontal axis of said “drop-shaped” form of said modulation law, and said predetermined back extended part of “drop-shaped” form of said modulation law is changed a form of a predetermined degree function curve such that an initial value of said degree function curve coincides with an ending value of said quarter ellipse curve.

The above-mentioned predetermined “drop-shaped” form of said law of said negative modulating includes providing a predetermined value of time ratio of said predetermined front time into said predetermined period of said negative modulating, and a value of said predetermined time ratio is selected from the range: more than 0 and less than 0.5. The value of time ratio is an additional predetermined modulation parameter of said negative modulating and can be changeable in dependence on a changes of a value of at least one a characteristic connected with said dynamic medium flow process to provide a minimal value of energy ratio of a controlled in action value of said modulated medium flow-forming energy into a controlled in action value of a form kinetic energy of said modulated medium flow during said dynamic medium flow process for dynamic structure-energetically optimization, in an energy-effective manner, of said process.

Said changes of said value of time ratio can include:
changing a predetermined front time and providing a predetermined period of said negative modulating simultaneously;
changing a predetermined period of said negative modulating and providing a predetermined front time simultaneously;
changing a predetermined front time and a predetermined period of said negative modulating simultaneously.

In accordance with another feature of the present invention, the modulated medium flow includes providing a predetermined comparative phase of a negative modulating is changed to provide a phase shift to a comparative phase of said independent predetermined periodic process. At the same time the independent predetermined periodic process includes providing a frequency, a range, a law and a comparative phase of a predetermined periodic parametric changes.

The above-mentioned independent predetermined periodic process can include, without any limitation, for example:
providing a modulating a value of a medium flow-forming energy action of at least one an additional means of medium flow-forming energy action directly connected with said modulated medium flow;
providing a modulating a value of a medium flow-forming energy action of at least one an additional means of medium flow-forming energy action connected with said modulated medium flow across at least one a medium flow action working zone including at least one a medium flow action object.

The above-mentioned medium flow action working zone can include at least one a perforating admission to provide the perforated medium flows; and the above-mentioned medium flow action object can be, without any limitation, for example:
the porous structure object;
the filter structure object;
the porous medium saturated object;
the constructive structure object;
the specific detection object.

In accordance with another feature of the present invention, said independent predetermined periodic process can include, without any limitation, for example:
providing a predetermined periodic injection said modulated medium flow inside at least one a working zone;
providing a predetermined periodic injection of said modulated medium flow inside at least one a working zone for a realization of a technological process in said working zone including at least one a medium flow action object;
providing a predetermined periodic energy action on said modulated medium flow injected inside at least one a working zone for a realization of a process of energy converting of said modulated medium flow in said working zone (for example: an injected modulated medium flow burning zone, or an injected modulated fuel flow burning zone into a combustion chamber of internal combustion engine).

The above-mentioned independent predetermined periodic process can include providing a modulating a value of a medium flow-forming energy action of at least one an additional means of medium flow-forming energy action connected with an additional modulated medium flow, which constructive separated from said general modulated medium flow. At the same time the constructive separated additional modulated medium flow and said modulated medium flow are predetermined simultaneously, to provide, without any limitation, for example:
the heat-transferring process into a “double-canal” heat exchanger includes an interior and an exterior heat transfers;
the movement process of at least one an object constructive connected with said modulated medium flows.

Said independent predetermined periodic process can include and providing a modulating a value of a medium flow-forming energy action of at least one a additional means of medium flow-forming energy action connected with an additional modulated medium flow, which constructive directly is not connected with said modulated medium flow.

In accordance with another feature of the present invention, said providing said minimal value of energy ratio (which is named by authors—“modulated medium flow energy optimizing criterion of Relin-Marta”) look toward provides of a minimal value (in the abstract—up to equal one) for keep up a superconductive energy regime of said modulated medium flow transporting (superconductive flow).

At the same time the controlled in action value of said modulated medium flow-forming energy can be evaluated by use, for example: a controlled in action value of a modulated medium flow pressure, providing of said means of medium flow-forming energy action; or a controlled in action value of at least one a energy parameter, connected with a value of energy consumption of said means of medium flow-forming energy action.

The above-mentioned controlled in action value of said formed kinetic energy of said modulated medium flow can be evaluated by use, for example: a controlled in action value of a modulated medium flow velocity and a predetermined value of a flow medium density; or a controlled in action value of a modulated medium flow velocity and a controlled in action value of a flow medium density.

A new method makes possible a realization of one of several main variants of said negative modulating a value of the medium flow-forming energy action includes providing, for example:
an interior modulating process, which realizes the principle of controlled interior dynamic shunting of a suction and a power working zones of said means of medium flow-forming energy action, as disclosed for example in U.S. Pat. No. 6,827,528 (2004)—A. Relin;
an exterior modulating process, which realizes the principle of controlled exterior dynamic shunting of a selected portion of a modulated suction medium flow, connected with a suction working zone of said means of medium flow-forming energy action, as disclosed for example in U.S. Pat. No. 5,593,252 (1997)—A. Relin, et al;
an interior modulating process, which realizes the principle of controlled interior dynamic shunting of a suction and a power working zones of said means of medium flow-forming energy action, and an exterior modulating process, which realizes the principle of controlled exterior dynamic shunting of a selected portion of a modulated suction medium flow, connected with a suction working zone of said means of medium flow-forming energy action, simultaneously;
the controlled predetermined dynamic periodic change of a value of at least one a parameter, dynamically connected with a process of a conversion of a consumption energy to said modulated medium flow-forming energy action realizable in said means of medium flow-forming energy action, as disclosed for example in U.S. Pat. No. 6,827,528 (2004)—A. Relin.

In accordance with another feature of the present invention, said dynamic shunting includes providing a controlled predetermined dynamic periodic connection of said modulated suction medium flow with a modulated shunt medium flow, realizing around of said modulated suction medium flow. At the same time the above-mentioned negative modulating comprises a modulation discrete input and an optimization parametric input.

In some cases of utilization of the new method of energy optimizing makes possible a realization providing a maximal value of energy efficiency of said dynamic medium flow process by changing a value of at least one said modulation parameter in dependence on a change of a value of at least one a characteristic connected with said dynamic medium flow process to dynamic structure-energetically optimize, in an energy-effective manner, said dynamic medium flow process. The energy optimizing can provide a possibility to use the different characteristics connected with said dynamic medium flow process, for example, without any limitation, as disclosed in U.S. Pat. No. 6,827,528.

The novel features which are considered as characteristic for the present invention are set forth in particular in the appended claims. The invention itself, however, both as to its construction and new method of operation, together with additional objects and advantages thereof, will be best understood from the following description of specific embodiments when read in connection with the accompanying drawings.

### BRIEF DESCRIPTION OF THE DRAWINGS

FIG. 1 is a view showing one of possible variants of a scheme of a functional structure of a dynamic transporting system comprising two identical dynamic subsystems, includes means of medium flow-forming energy action (example of the pump) and an energy-saving dynamic module (connected with the means) each for providing a dynamic medium flow pipeline transporting process, which realizes a new method of dynamic energy-saving superconductive transporting of medium flow in accordance with the present invention;

FIG. 2 is a view showing one of possible variants of a scheme of a functional structure of an energy-saving dynamic module connected with a pump in a dynamic subsystem, which realizes a new method of dynamic energy-saving superconductive transporting of medium flow in accordance with the present invention;

FIG. 3 is a view showing a diagram of an example of a predetermined “drop-shaped” form of a law of dynamic periodic change of a value of interior modulating connection between working zones of the pump, provided by an energy-saving dynamic module, which realizes the principle of controlled interior dynamic shunting of a suction and a power working zones of the means (pump) of medium flow-forming energy action;

FIG. 4 is a view showing a diagram of an example of a predetermined “drop-shaped” form of a law of simultaneous dynamic periodical change (negative modulating) of a value of flow-forming positive overpressure in a power working zone and a value of flow-forming negative overpressure in a suction working zone of the means (pump) of medium flow-forming energy action;

FIG. 5 is a view illustrating one of possible variants of a change of a value of energy ratio of a controlled in action value of a modulated medium flow-forming energy into a controlled in action value of a formed kinetic energy of a modulated medium flow in dependence on a change of a value of at least one a modulation parameter (frequency) during a dynamic structure-energetically optimization of the turbulent flow;

FIG. 6 is a view illustrating one of possible variants of a schematically presentation of a process of a change of a value of a hydrodynamic vectorization and a domination size of a medium particles of a modulated turbulent medium flow in dependence on a change of a value of at least one a modulation parameter (frequency) during a dynamic structure-energetically optimization of the turbulent flow;

FIG. 7 is a view illustrating one of possible variants of a change of a value of dissipation energy of a modulated turbulent medium flow in dependence on a change of a value of at least one a modulation parameter (frequency) during a dynamic structure-energetically optimization of the turbulent flow;

FIG. 8 is a view illustrating one of possible variants of a change of a value of kinetic energy of a modulated turbulent medium flow in dependence on a change of a value of at least one a modulation parameter (frequency) during a dynamic structure-energetically optimization of the turbulent flow;

FIG. 9 is a view showing a diagram of an example of a phase shift, providing between a predetermined comparative phases of two related processes of predetermined “drop-shaped” negative modulating of a value of medium flow-forming energy action, which realizes simultaneous the energy-saving dynamic modules with a first and a second means (pumps) of medium flow-forming energy action relatively, for providing a modulated medium flow pipeline transporting system process;

FIG. 10 is a view illustrating one of possible variants of a change of a value of energy ratio of a controlled in action value of a modulated medium flow-forming energy into a controlled in action value of a formed kinetic energy of a modulated medium flow of a transporting system, comprising two means (pumps) of a modulated medium flow-forming energy action for providing a dynamic medium flow transporting system process, in dependence on a change of a value of a phase shift between two related flow modulating processes during a dynamic structure-energetically optimizing of a modulated medium flow pipeline transporting system process.

### DESCRIPTION OF THE PREFERRED EMBODIMENTS

A proposed new method of dynamic energy-saving superconductive transporting of medium flow can be realized in the following manner.

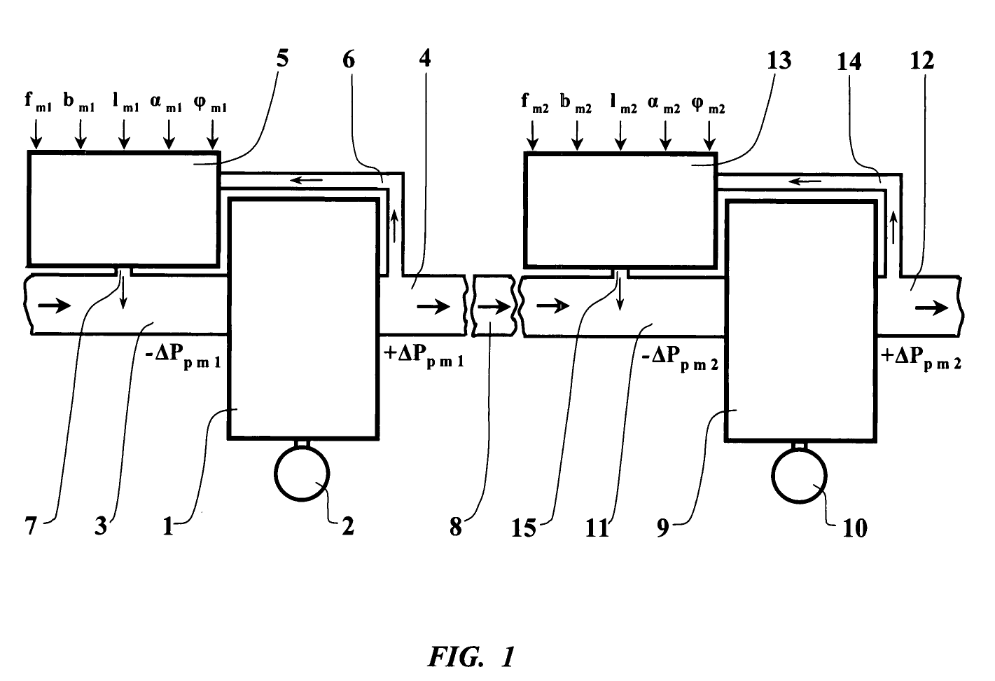

One of the possible variants of a scheme of a functional structure of a dynamic transporting system comprising two identical dynamic subsystems, includes means of medium flow-forming energy action (pump) and an energy-saving dynamic module (connected with the means) each for providing a dynamic medium flow pipeline transporting process is shown in FIG. 1. The first dynamic subsystem includes a pump 1 representing a cycling drive means for transporting medium (for example—oil) flow entrained therein through an enclosed passage and having a first working zone in a negative drive cycle (a negative overpressure −Δₚ₁ is generated) and a second working zone in a positive drive cycle (a positive overpressure +ΔPₚ₁ is generated). It has further a drive 2 for the pump 1, a suction part of a pipeline 3 and a power part of a pipeline 4, an energy-saving dynamic module (which is named by authors—ESDM) 5 connected with the power part of pipeline 4 and the suction part of pipeline 3 correspondingly through an longer inlet portion of a module shunt channel 6 and an short outlet portion of a module shunt channel 7. An extended part of pipeline 8 connects the first dynamic subsystem with identical second dynamic subsystem, that includes a pump 9 representing a cycling drive means for transporting medium (oil) flow entrained therein through an enclosed passage and having a first working zone in a negative drive cycle (a negative overpressure −ΔPₚ₂ is generated) and a second working zone in a positive drive cycle (a positive overpressure +ΔPₚ₂ is generated). It has further a drive 10 for the pump 9, a suction part of a pipeline 11 and a power part of a pipeline 12, an energy-saving dynamic module 13 connected with the power part of pipeline 12 and the suction part of pipeline 11 correspondingly through an longer inlet portion of a module shunt channel 14 and an short outlet portion of a module shunt channel 15.

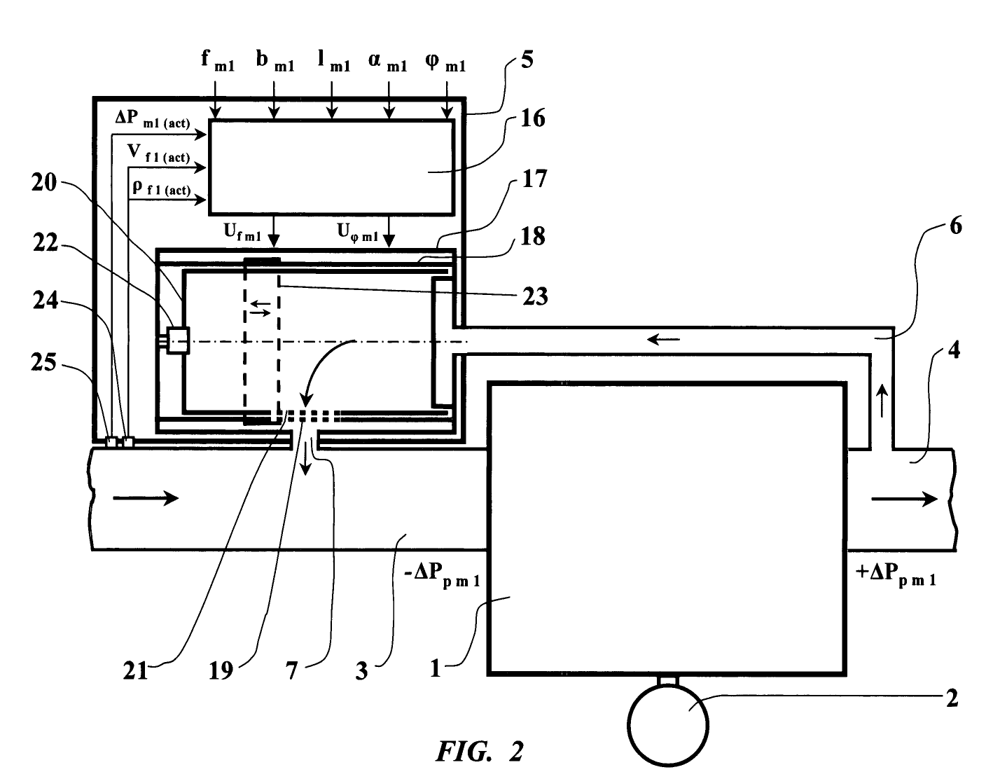

One of possible variants of a scheme of a functional structure of the energy-saving dynamic module 5 connected with the pump 1 in the first dynamic subsystem, which realizes the new method of dynamic energy-saving superconductive transporting of medium flow in accordance with the present invention is shown in FIG. 2. The dynamic module 5, which realizes the “Principle of controlled inner dynamic shunting” of working zones of the pump 1, functionally (generally) includes a microprocessor control block 16, a body of a valve block 17 whose inner cavity is connected correspondingly by an inlet to the longer inlet portion of the module shunt channel 6 and by an output—with the short outlet portion of the module shunt channel 7, an immovable cylindrical valve element 18 having a passing channel 19, a movable cylindrical valve element 20 having a passing channel 21, a drive 22 of the movable cylindrical valve element 20, a control element (for example, ring) 23, a sensor 24 controls a in action value of a pipeline medium flow velocity V_{f1(act)} and a in action value of a pipeline medium flow density ρ_{f1(act)}, and a sensor 25 controls a in action value of a modulated pipeline medium flow pressure ΔP_{pm1(act)}.

The sensor 24 controls a in action value of a pipeline medium flow velocity V_{f1(act)} and a in action value of a pipeline medium flow density ρ_{f1(act)}, for example, can be a two-channel half-ring high-frequency capacitor sensor realized with use of the “SCP measurement technology”, such as those disclosed in U.S. Pat. No. 5,502,658 (1996)—A. Relin, “Sampled-Continuous Probability Method of Velocity Measurement of the Object Having Informatively-Structural Inhomogeneity” or in the book “The Systems of Automatic Monitoring of Technological Parameters of Suction Dredger”—A. Relin, Moscow, 1985. The microprocessor control block 16 having three optimization parametric inputs connected with two outputs of the sensor 24 (signal V_{f1(act)} and signal ρ_{f1(act)}) and output of the sensor 25 (signal ΔP_{pm1(act)}); five modulation discrete inputs for setting of a predetermined modulation parameters (a frequency fₘ₁, a range bₘ₁, a law lₘ₁, a comparative phase φₘ₁ of the negative modulating a value of the medium flow-forming energy action of the pump 1 and time ratio αₘ₁ of a “drop-shaped” form of the law lₘ₁); and a two controlling outputs (signal U_{fm1} and signal U_{φm1}) connected with the drive 22 of the movable cylindrical valve element 20.

The immovable cylindrical valve element 18 with the passing channel 19, the movable cylindrical valve element 20 with the passing channel 21, the drive 22 of the valve element 20, control element 23 and a body of a valve block 17 providing one of possible variants of a scheme of a functional structure of a cylindrical valve block of the energy-saving dynamic module 5, which realizes a new predetermined “drop-shaped” form of a law lₘ₁ of dynamic periodic change of a value of interior modulating connection Cₘ₁ between the working zones of the pump 1. At that a cutting of the passing channel 19 having a predetermined “drop-shaped” form (half of a “drop”) with predetermined sizes, and a longer longitudinal axis of the cutting consists with a line of cross-section circle of the immovable cylindrical valve element 18. A cutting of the passing channel 21 having a predetermined linear rectangular form with predetermined sizes, and a longer longitudinal axis of the cutting is parallel to a longitudinal axis of the movable cylindrical valve element 20. The control (ring) element 23 can have a various shaped width and is used for providing (setting or correcting) of initial area and shape of a cross-section of the passing channel, which is formed by the passing channels 19 and 21 during the process of rotation of the movable cylindrical valve element 20 relatively to the immovable cylindrical valve element 18. The control element 23 has a possibility of a given linear or given angular movement relatively to the passing channel 19 for providing (setting or correcting) of initial area and shape of the cross-section of thusly-formed passing channel. The short outlet portion of the module shunt channel 7 has a minimal length for providing of a minimal distance between the cross-section of thusly-formed passing channel and the modulated suction pipeline medium flow.

The scheme of a functional structure of the dynamic module 13, which as well as realizes the “Principle of controlled inner dynamic shunting” of working zones of the pump 9, realizing completely by analogy with the scheme of the above-mentioned functional structure of the dynamic module 5. The microprocessor control block of the dynamic module 13 also having three analogical optimization parametric inputs (signal V_{f2(act)} and signal ρ_{f2(act)} from a sensor controls a in action value of a pipeline medium flow velocity V_{f2(act)} and a in action value of a pipeline medium (oil) flow density ρ_{f2(act)} in the dynamic module 13, as well as—signal ΔP_{pm2(act)} from a sensor controls a in action value of a modulated pipeline medium flow pressure ΔP_{pm2(act)} in the dynamic module 13); five modulation discrete inputs for setting of a predetermined modulation parameters (a frequency fₘ₂, a range bₘ₂, a law lₘ₂, a comparative phase φₘ₂ of the negative modulating a value of the medium flow-forming energy action of the pump 9 and time ratio αₘ₂ of a “drop-shaped” form of the law lₘ₂); and two control outputs (signal U_{fm2} and signal U_{φm2}) connected with the drive of the movable cylindrical valve element in the body of a modulator of the dynamic module 13. The functional elements of the dynamic module 5 and the dynamic module 13 make possible providing of optimal parameters of theirs operation, as shown in FIG. 1 and FIG. 2.

The above-described dynamic medium flow control transporting system for providing a dynamic medium flow process that realizes the new method of dynamic energy-saving superconductive transporting of medium flow in accordance with the present invention operates in the following manner.

After turning on the drive 2 of the pump 1 in the first dynamic subsystem, the pump 1 starts generating a working pressure difference ΔPₚ₁− medium (oil) flow-forming energy action, applied to a oil medium and generating an oil flow in the suction part of pipeline 3 and the power part of pipeline 4 in FIGS. 1 and 2. In the described initial position of operation of the first dynamic subsystem, when the energy-saving dynamic module 5 (connected with the power part of pipeline 4 and the suction part of pipeline 3 correspondingly through an longer inlet portion of a module shunt channel 6 and an short outlet portion of a module shunt channel 7) is turned off, an area of a cross-section of the thusly-formed passing channel of the valve block is equal to zero. This correspondingly determines a zero (minimal) value Cₘ₁₍ₘᵢₙ₎ of the modulating connection Cₘ₁, between the working zones of the pump 1, provided by the dynamic module 5, which realizes the above-mentioned “Principle of controlled interior dynamic shunting” of the first (−ΔPₚ₁) and second (+ΔPₚ₁) working zones of the pump 1. After turning on of the dynamic module 5, the drive 22 starts to rotate the movable cylindrical valve element 20. Passing channels 19 and 21 start superposing with one another, which determines a dynamic change of the area of cross-section of the thusly-formed passing channel of the valve block. When the area of the cross-section of the thusly-formed passing channel reaches a maximal value, a maximal value Cₘ₁₍ₘₐₓ₎ of the modulating connection Cₘ₁ of the working zones of the pump 1 by oil flow is provided.

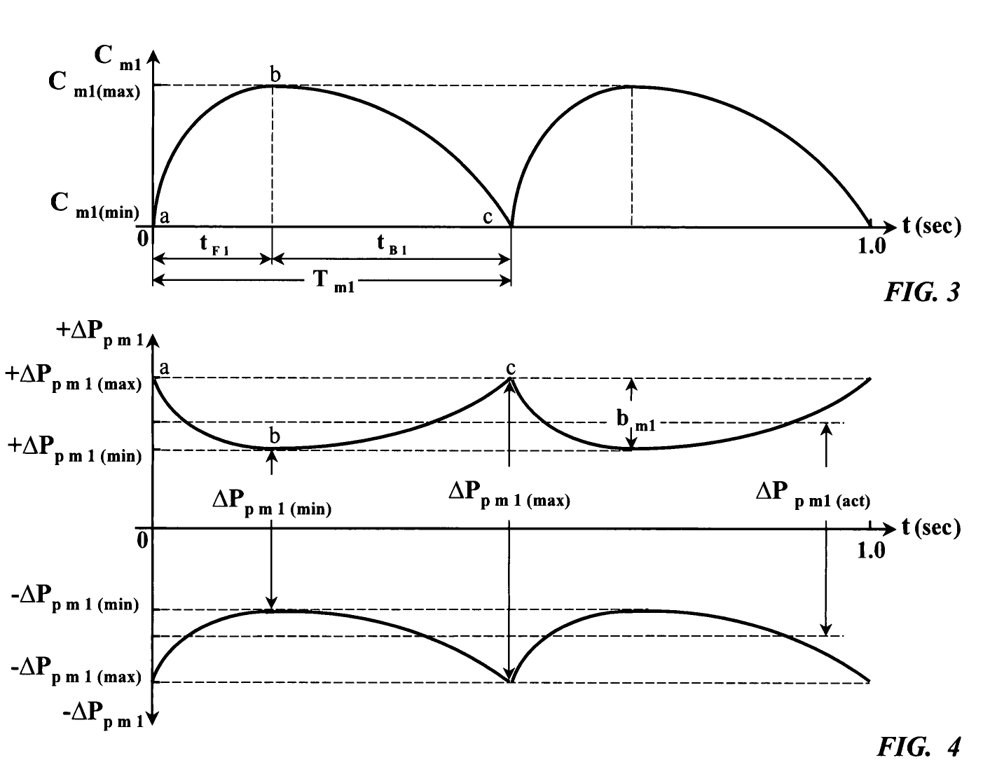

The above-mentioned cutting forms of the passing channel 19 of the immovable cylindrical valve element 18 and passing channel 21 of the movable cylindrical valve element 20 providing a realization of the predetermined “drop-shaped” form of a law of dynamic periodic change of a value of interior modulating connection Cₘ₁ between the working zones of the pump 1 (see FIG. 3). The predetermined periodical (with a predetermined period Tₘ₁) of the modulating connection Cₘ₁ is determined by a speed of rotation of the drive 22 of the movable cylindrical valve element 20. At the same time, the each predetermined period Tₘ₁ of the change of value of interior modulating connection Cₘ₁ includes providing increase of the value Cₘ₁ from the minimal value (zero) Cₘ₁₍ₘᵢₙ₎ to the maximal value Cₘ₁₍ₘₐₓ₎ during a predetermined front time t_{F1} of realizing a predetermined front short part of said “drop-shaped” form of said law (see the diagram part “a-b”), and providing decrease of the value Cₘ₁ from the maximal value Cₘ₁₍ₘₐₓ₎ to the minimal value (zero) Cₘ₁₍ₘᵢₙ₎ during a predetermined back time t_{B1} of realizing a predetermined back extended part of said “drop-shaped” form of said law (see the diagram part “b-c”). The predetermined diagram part “a-b” is changed a form of a predetermined quarter ellipse curve such that a horizontal axis of said ellipse coincided with a horizontal axis of said “drop-shaped” form. The predetermined diagram part “b-c” is changed a form of a predetermined degree function curve such that an initial value of said degree function curve coincides with an ending value of said quarter ellipse curve.

In turn, the predetermined change of value of interior modulating connection Cₘ₁ in each predetermined period Tₘ₁ leads to a simultaneous predetermined dynamic periodic change (modulating) of the value of the modulated negative overpressure −ΔPₚₘ₁ and the value of the modulated positive overpressure +ΔPₚₘ₁ in each period of their changes in corresponding suction and power working zones of the pump 1 (FIG. 4). Herewith, the value of the modulated negative overpressure −ΔPₚₘ₁ is dynamically periodically changes in a predetermined range bₘ₁ of the negative modulating: from the −ΔPₚₘ₁₍ₘₐₓ₎ to the −ΔPₚₘ₁₍ₘᵢₙ₎, while the value of the modulated positive overpressure +ΔPₚₘ₁ simultaneously periodically changes within a predetermined range bₘ₁ of the negative modulating: from the +ΔPₚₘ₁₍ₘₐₓ₎ to the +ΔPₚₘ₁₍ₘᵢₙ₎. The above-mentioned maximal values of the overpressures −ΔPₚₘ₁₍ₘₐₓ₎ and +ΔPₚₘ₁₍ₘₐₓ₎ correspond to a moment when the area of a cross-section of the thusly-formed passing channel of the valve block is equal to zero (minimal value Cₘ₁₍ₘᵢₙ₎). The above-mentioned minimal values of the overpressures −ΔPₚₘ₁₍ₘᵢₙ₎ and +ΔPₚₘ₁₍ₘᵢₙ₎ correspond to a moment when the area of a cross-section of the thusly-formed passing channel of the valve block is maximal (maximal value Cₘ₁₍ₘₐₓ₎). This situation occurs in each period Tₘ₁ of the periodically repeating displacements of the movable cylindrical valve element (with the predetermined frequency of the negative modulating fₘ₁=1/Tₘ₁).

Therefore, as a result of the above-mentioned dynamic periodic shunting interactions of the elements of the energy-saving dynamic module 5 with corresponding the suction and power working zones of the pump 1, the predetermined negative modulating of the value of the pressure drop ΔPₚₘ₁ (oil flow-forming energy action) in the predetermined range bₘ₁ of its dynamic periodic change (ΔPₚₘ₁₍ₘₐₓ₎−ΔPₚₘ₁₍ₘᵢₙ₎) is performed during the process of transporting of the medium flow. The negative modulating of the value of the pressure drop ΔPₚₘ₁ is performed along the law lₘ₁ of the “drop-shaped” form (FIG. 4), which providing:
decrease of the value of said flow-forming energy action ΔPₚₘ₁ from a current maximal value ΔPₚₘ₁₍ₘₐₓ₎ on a predetermined value of said range bₘ₁ of modulating (until ΔPₚₘ₁₍ₘᵢₙ₎) during a predetermined front time t_{F1} of realizing a predetermined front short part l_{m1(a-b)} (see the diagram part “a-b”) of said “drop-shaped” form of said law lₘ₁ during an each predetermined period Tₘ₁ of said negative modulating, which is changed a form of a predetermined quarter ellipse curve such that a horizontal axis of said ellipse coincided with a horizontal axis of said “drop-shaped” form of said modulation law lₘ₁; recovery of a value of said medium flow-forming energy action ΔPₚₘ₁ until said current maximal value ΔPₚₘ₁₍ₘₐₓ₎ during a predetermined back time t_{B1} of realizing a predetermined back extended part l_{m1(b-c)} (see the diagram part “b-c”) of said “drop-shaped” form of said law lₘ₁ during an each predetermined period Tₘ₁ of said negative modulating, which is changed a form of a predetermined degree function curve such that an until value of said degree function curve coincides with an ending value of said quarter ellipse curve ΔPₚₘ₁₍ₘᵢₙ₎ to provide a predetermined period Tₘ₁ of said modulating; predetermined value of time ratio αₘ₁ of said predetermined front time t_{F1} into said predetermined period Tₘ₁ of said negative modulating, which is an additional predetermined modulation parameter of said negative modulating (αₘ₁=t_{F1}/Tₘ₁) and is selected from the range: more than 0 and less than 0.5

The above-mentioned so-called “drop-shaped modulating law of Relin-Marta” lₘ₁ (for above-mentioned example) is being described by two expressions:

l_{m1(a-b)}=ΔPₚₘ₁₍ₘₐₓ₎−bₘ₁·[1−(1−t/t_{F1})²]^{1/2}, for 0≦t≦t_{F1}; and

l_{m1(b-c)}=(ΔPₚₘ₁₍ₘₐₓ₎−bₘ₁)+bₘ₁·(t−t_{F1})^{θ}/(Tₘ₁−t_{F1})^{θ}, for t_{F1}≦t≦Tₘ₁;

and where θ>1 (depends on t_{F1}, Tₘ₁ and bₘ₁).

The in action value of said modulated medium flow-forming energy is evaluated by use of a controlled in action value of a modulated medium flow pressure ΔP_{pm1(act)}. A modulating pressure ΔPₚₘ₁ (modulating energy action) wave is formed under rotation of movable cylindrical valve element 20 of the valve block by superposition of cross-section of the passing cannel 21 of the movable valve element 20 and cross-section of the passing cannel 19 of the immovable element 18 of the valve block, executing a commutation of the pressure zone +ΔPₚₘ₁ of the longer inlet portion of shunt cannel 6 with the pressure zone −ΔPₚₘ₁ of the short outlet portion of shunt cannel 7 of the energy-saving dynamic module 5. The formed modulating pressure ΔPₚₘ₁ wave spreads through short outlet portion of shunt cannel 7 in the suction part of pipeline 3 and further in the power part of pipeline 4 along the longitudinal axis of the oil flow. The short outlet portion of the module shunt channel 7 provides the minimal distance between the cross-section of thusly-formed passing channel and the modulated suction pipeline medium flow, which due to significant reduction of the time of “running” of a commutation pressure wave in the shunting channel and allows to provide the “drop-shaped” form of said modulation law lₘ₁ with minimal distortion. The spread of modulating pressure waves in the flow pipeline is fulfilled in the form of plane waves, which realize an energy maximal wave action on turbulence and a boundary layer of medium flow in the pipeline. The predetermined frequency fₘ₁ of said modulating is changed to provide a plane form of a modulating energy action ΔPₚₘ₁ flow longitudinal waves in the pipeline, in respect that a spread velocity of the waves in the pipeline medium (oil) flow C_{fm} and pipeline diameter dₚ, which are connected by relation: fₘ₁<<0.3·C_{fm}/dₚ.

The authors researches by using of the experimental results confirmed, that their proposed the optimal “drop-shaped” form of modulating law Iₘ₁₍ₒₚₜ₎ is most energy efficient (in comparison with the another possible known forms of a modulating law, for example: sinusoidal, rectangular, triangular, trapezoidal, etc.) for bring in a medium flow the modulated medium flow-forming energy. Besides, the optimal “drop-shaped” modulating law lₘ₁₍ₒₚₜ₎ (take into consideration its given naturally form) efficient joins all of the basic predetermined modulation parameters of said negative modulating of medium flow-forming energy between them. It is the basis of the first created mathematical modulation-hydrodynamical model for computer search of optimal modulation parameters: fₘ₁₍ₒₚₜ₎, bₘ₁₍ₒₚₜ₎, αₘ₁₍ₒₚₜ₎. The above-mentioned so-called “drop-shaped modulating modulation-hydrodynamical model of Relin-Marta” is first created with use of the unique experimental information and so-called “modulated medium flow energy optimizing criterion of Relin-Marta” E_{Rm1} (for above-mentioned example) is being described by the expression:

E_{Rm1}=E_{ffm1(act)}/E_{km1(act)}=ΔP_{pm1(act)}/(ρ_{f1(act)}·V²_{f1(act)}/2), where
E_{ffm1(act)}—a controlled in action value of dynamic flow-forming energy action,
E_{km1(act)}—a controlled in action value of kinetic energy of the medium flow,
ΔP_{pm1(act)}—a controlled in action value of modulated medium flow pressure,
ρ_{f1(act)}—a controlled in action value of a pipeline medium (oil) flow density, and
V_{f1(act)}—a controlled in action value of a pipeline medium (oil) flow velocity.

In accordance with another feature of the present invention, providing a minimal value of said energy ratio (energy optimizing criterion E_{R}) look toward provides a minimal value (in the abstract—up to equal one) for keep up a superconductive energy regime of said modulated medium flow transporting (superconductive flow). The values of the above-mentioned optimal modulation parameters: fₘ₁₍ₒₚₜ₎, bₘ₁₍ₒₚₜ₎, αₘ₁₍ₒₚₜ₎ (by use of the “drop-shaped” modulating law lₘ₁₍ₒₚₜ₎) corresponding to the estimated minimal value of energy optimizing criterion E_{Rm1(min)} to provide said superconductive energy regime. It is determined from the functional dependence of E_{Rm1} can be obtained, for example, on the base of computer modeling by use of the above-mentioned “drop-shaped” modulating hydrodynamical model and Pi theorem of dimensional analysis. Said determines a correlation of the criterion E_{Rm1} with modulation and Reynolds criterions, depending on a values of the modulation parameters and the parameters medium flow pipeline system: a maximal pump energy action ΔPₚₘ₁₍ₘₐₓ₎, a pipeline length Lₚ, a pipeline diameter dₚ, a controlled in action value of a pipeline medium (oil) flow velocity V_{f1(act)}, a controlled in action value of a pipeline medium (oil) flow density ρ_{f1(act)}, a medium flow dynamic viscosity μ_{fl}, and also—a medium flow dynamic “modulating viscosity” μ_{fm1}. Said complex of parameters reflects the dynamic, structure-rheological and temperature possible changes as in one phase as and in multiphase homogeneous and heterogeneous fluid medium flows. The temperature changes of one phase fluid medium flow predetermine the changes of a pipeline medium flow density ρ_{f1(act)}, a medium flow dynamic viscosity μ_{f1} and a medium flow dynamic “modulating viscosity” μ_{fm1}. In the multiphase fluid medium flow a magnitude μ_{fm1} reflects its average viscosity, which depends on a volume concentration of each phase and its dynamic distribution on a pipeline cross-section. It also takes into consideration the orientations of multi-particles clusters (for example, in the disperse mixtures) of different forms (chains, triangles, hexagons, etc.) relatively of a medium flow velocity. For example, the longitudinal intensification of particles movements with sign-alternating acceleration leads to decrease of the interphase friction force. This lead to increase of said value of kinetic energy of the heterogeneous multiphase medium flow. Thus, the consideration of said complex of parameters are very important for complete describing and energy optimization of the dynamic processes of medium flow pipeline transporting of the heterogeneous and multiphase fluid medium flows in the power-consuming fields (for example, in the powder, oil and natural gas pipeline transporting technologies; in the technologies of the hydro-transporting of sand, coal and other minerals ores; etc.).

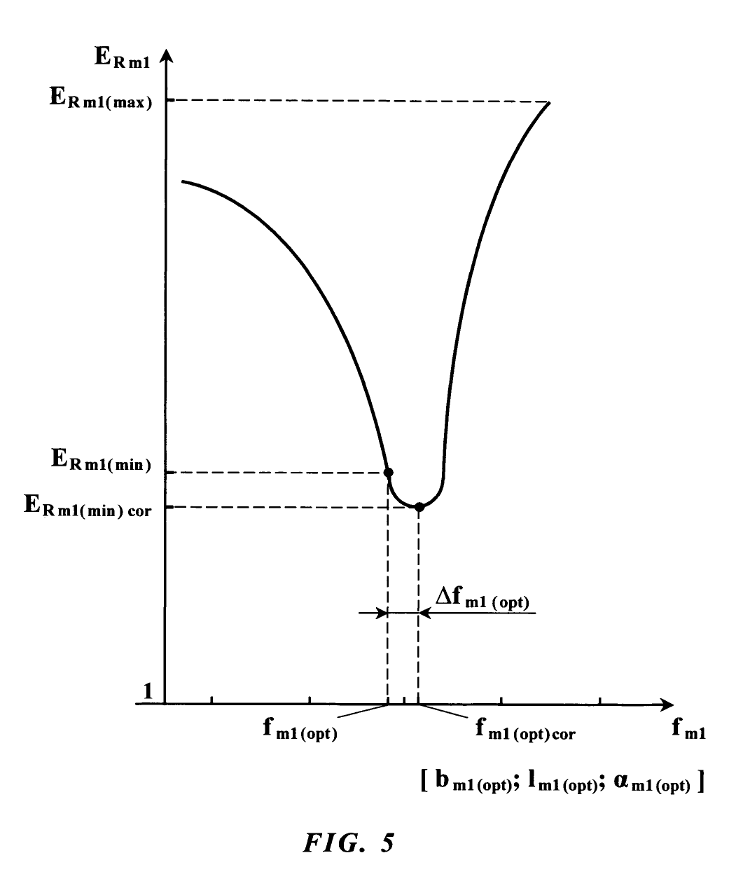

The above-mentioned scheme of a functional structure of the energy-saving dynamic module 5 (see FIGS. 1 and 2) provides the computer estimated optimal modulation parameters: fₘ₁=fₘ₁₍ₒₚₜ₎, bₘ₁=bₘ₁₍ₒₚₜ₎, lₘ₁=lₘ₁₍ₒₚₜ₎ and αₘ₁=αₘ₁₍ₒₚₜ₎, in the microprocessor control block 16 and also—in the functional elements of the valve block. Herewith, the optimal modulation parameters: lₘ₁₍ₒₚₜ₎, bₘ₁₍ₒₚₜ₎, and αₘ₁₍ₒₚₜ, constructional used in the cutting of the passing channel 19 having a predetermined “drop-shaped” form. The estimated value of optimal modulation parameter fₘ₁₍ₒₚₜ₎, realizable of the predetermined estimated value of the rotation velocity of the drive 22 of the movable cylindrical valve element 20, is initial exercised by the control outputs of the microprocessor control block 16 (signal U_{fm1} connected with the drive 22) to provide the estimated minimal value of energy optimizing criterion E_{Rm1(min)}, significantly discrepant from the practicable value of E_{Rm1(max)} (see FIGS. 5). The above-mentioned sensor 24 and sensor 25 provide control of the values of technological parameters: V_{f1(act)}, ρ_{f1(act)} and ΔP_{pm1(act)}, incoming in the microprocessor control block 16 for calculation of an initial real value of energy optimizing criterion E_{Rm1(min)}. The microprocessor-controlled optimization retrieval of a minimal-practicable value of E_{Rm1(min)cor} (when the derivative dE_{Rm1(min)}/dt=0) providing the change (to Δ_{fm1(opt)}) of the estimated value of optimal modulation parameter fₘ₁₍ₒₚₜ₎ until the correction value f_{m1(opt)cor} by the change of the signal U_{fm1} (to U_{fm1cor}) connected with the drive 22 and changing its rotation velocity.

From the definition of expression for E_{Rm1} follows that it achieves the minimal value E_{Rm1(min)cor} only when the controlled in action value of dynamic flow-forming energy action E_{ffm1(act)}=ΔP_{pm1(act)} achieves the minimal value (for f_{m1(opt)cor}) at the particular values of the technological parameters V_{f1(act)} and ρ_{f1(act)}. The minimal value of controlled in action value of modulated medium flow pressure ΔP_{pm1(act)} is the quantity of energy, which is necessary to effectuate a work against the turbulent friction stress in the nucleus of medium flow and in its boundary layer for maintain the controlled in action value of kinetic energy of the medium flow E_{km1(act)}=ρ_{f1(act)}·V_{f1(act)}²/2, which achieves the maximal value. The value of ΔP_{pm1(act)} significantly depends of the turbulence structure and state of boundary layer of modulated medium flow. Thus, physical meaning of the magnitude ΔP_{pm1(act)} is reciprocally to the pressure losses on the pipeline of length Lₚ and diameter dₚ, at the controlled in action value of a pipeline medium (oil) flow velocity V_{f1(act)}, the controlled in action value of a pipeline medium (oil) flow density ρ_{f1(act)}, the medium flow dynamic viscosity μ_{f1}, and also—the medium flow dynamic “modulating viscosity” μ_{fm1}. Herewith, the minimal value of controlled in action value of modulated medium flow pressure ΔP_{pm1(act)} characterizes the minimal value of hydrodynamic resistance of modulated medium flow, which is obtained at the above-mentioned minimal value E_{Rm1(min)cor} by the microprocessor-controlled optimization retrieval (the physical phenomena—“superconductive” modulated medium flow, as it is first named by Dr. A. Relin, USA in PCT/US2004/039818, 2004).

The experimental and theoretical researches, also the computer simulation of the energy optimizing process of modulating of energy of plane pressure waves (performed by authors) confirm, that the oil flow longitudinal plane “drop-shaped” form waves of modulated flow-forming energy action ΔPₚₘ₁ in the pipeline spread (with velocity about one mile in second) along the all oil flow to tens miles and cause the fundamentally new significant volume changes of the turbulent structure and boundary layer along all pipeline flow, also—a substantial modification of the overall turbulent kinetic energy.

The physical basis of choice of the “drop-shaped” form of flow-forming energy modulation law lₘ₁ is based on a possibility of providing the needed dynamic changes of turbulence and boundary layer of the modulated medium flow, which occur during the predetermined period Tₘ₁. During the predetermined back time t_{B1} a longitudinal redirect of large-scale particles and their velocities of movement in the flow have occurred. A probability of the formation of more large medium particles with principally longitudinal velocity of their movement is increased. Turbulent velocity pulsations of small-scale medium particles are also flowing longitudinal redirected. A stage t_{B1} of increase of wave pressure is accompanied by the attenuation of small-scale particles generating on the boundary layer surface. The flow turbulence suffers significant changes and becomes longitudinal anisotropy. Therefore, the thickness of boundary layer is decreased. From its surface the negative vertexes are generated. During a predetermined front time t_{F1} more quickly decrease of pressure, than its increase have occurred. A particles relaxation of the flow turbulence occurs differently. The small-scale quick-acting medium particles aspire to follow the pressure changes faster, than large-scale particles. Thus the intensity of small-scale turbulence is slightly increased. At the same time, the large-scale particles are more inert and during the front time t_{F1} their movements are only slightly disorientated. They maintain their hydrodynamic stability yet, but herewith, the forbidden state to their enlargement is appeared. The thickness of boundary layer is slightly increased.

At the same time, the spread of modulated pressure waves along a pipeline medium flow is accompanied by the dynamic elastic local oscillations of boundary layer. The frequency and amplitude of said elastic oscillations depend on the modulation wave parameters: fₘ₁, bₘ₁, lₘ₁ and αₘ₁; density ρ_{f1(act)} and compressibility βₘ₁ of medium flow. From the above-mentioned physical scene follows, that such “drop-shaped” form of modulation law lₘ₁ of flow-forming energy action allows to maintain in average (during the period Tₘ₁) the significantly longitudinal anisotropic dynamic state of turbulence and the less value of boundary layer thickness. To this dynamic state correspond the less turbulent intensity in the medium flow (and so—turbulent viscosity), which predetermines decrease of the medium flow energy dissipation. The mentioned needs that the front time t_{F1} of the “drop-shaped” form of flow-forming energy modulation law lₘ₁ must be less than the back time t_{B1}. Said condition predetermines the possibility of the selection of the time ratio αₘ₁=t_{F1}/Tₘ₁ (from the above-mentioned range: more than 0 and less than 0.5), considering the modulation, technological and system parameters of the dynamic medium flow transporting system. By giving the front time t_{F1} and the back time t_{B1} of modulated pressure wave of the “drop-shaped” form can provide practically constant velocity profile in the nucleus of pipeline medium flow. This establishes favorable conditions to form in the modulated flow a stable periodical toroidal whirlwind structures and another stable periodical ordered whirlwind formations (for example, cell structure), which sufficiently quick and easy are moving through the modulated medium flow.

Moreover, it is possible the forming of fundamentally new kinds of orientated and coherent whirlwind structures, which arise only in the modulated medium flow. Forming of such stable periodical ordered whirlwind structures in modulated flow also lead to significant decrease of its hydrodynamic resistance and to significant increase the kinetic energy of medium flow. At the same time, velocity of dynamic pressure changes dΔPₘ₁/dt also plays a significant (determinative) role in the changes state of turbulence and boundary layer of modulated medium flow. Said changes are indissoluble connected with the form of modulation law lₘ₁ during the front time t_{F1} and the back time t_{B1}. Therefore, the first proposed energy optimal “drop-shaped” form of flow-forming energy modulation law lₘ₁ allows to select the optimal values of the modulation parameters: frequency fₘ₁₍ₒₚₜ₎, range bₘ₁₍ₒₚₜ₎, front time t_{F1(opt)}, back time t_{B1(opt)} and time ratio αₘ₁₍ₒₚₜ₎ to provide the optimal minimal value of flow dissipation energy E_{dm1(min)}, optimal maximal value of flow kinetic energy Eₖₘ₁₍ₘₐₓ₎ and as the result—optimal minimal value of hydrodynamic resistance of modulated medium flow.

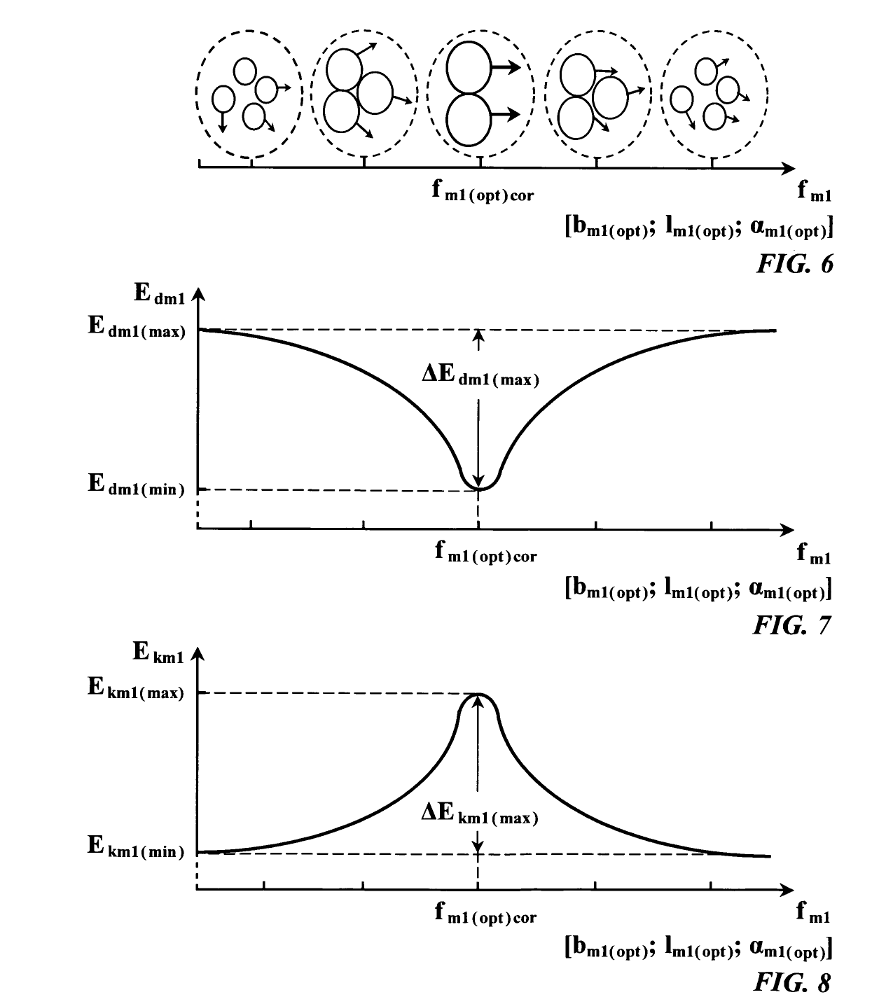

Herewith, the elementary medium flow particles effectuate the longitudinal movements with sign-alternating acceleration, normal to the fronts of said modulated plane pressure waves. The carried out by authors a wide computer modeling of the dynamic medium flow particle movements under an action of modulated pressure waves confirmed, that the spectrum of obtained “resonating” frequencies of medium flow particle oscillation movements with maximal amplitude for different flows media (for example, water or air) are different. Said “resonating” conditions depend on the density, viscosity and temperature of flow medium, have been established. The experiments also show (for example, in the above-mentioned modulated medium flow), that the optimal frequencies of said plane waves are arranged in the infra-low and low frequencies ranges. The spread of modulated plane pressure waves is accompanied by suppression of the turbulence on the inner pipeline surface. An energy action of modulated plane pressure waves in the flow lead to “interdict” of a avulsion of small scale vortexes from the boundary layer surface (a growth of their instability) that decrease their generation, and lead to growth of the stability of large scale vortexes. The presence of such additional mechanisms of instability in the flow action differently on the turbulence particles of different scales. The above-mentioned minimal value ER_{m1(min)cor} (for f_{m1(opt)cor}) lead to the optimization of maximal enlargement of turbulence particles and to their longitudinal vectorization movements (FIG. 6).

At the same time (for f_{m1(opt)cor}), the longitudinal movements of elementary medium flow particles with sign-alternating acceleration in the modulated flow serve as the continuous dynamic energy action of additional sources of hydrodynamic instability of boundary layer surface and hereupon its thickness and shear stress on the inner pipeline walls are decreased. These particle longitudinal movements increase the streamwise component of turbulent kinetic energy and decrease its azimuthally one. Therefore, a coefficient of turbulent viscosity is decreased and as a result, significant attenuation of the shear stress is occurred (especially in the pipeline wall layer). The modulated shear stress distribution is constantly below the steady one. Therefore, the dissipation energy into the boundary layer of modulated flow is decreased. These predetermine the optimization maximal decrease (on Δ_{Edm1(max)}) of the dissipation energy E_{dm1} of modulated medium flow from the maximal value E_{dm1(max)} to the minimal value E_{dm1(min)} (FIG. 7).

The oil flow longitudinal plane “drop-shaped” form wave of modulated flow-forming energy action ΔPₚₘ₁ in the pipeline is characterized by that the predetermined back time t_{B1} of realizing the predetermined back extended part of said “drop-shaped” form of the law lₘ₁₍ₒₚₜ₎ is more than the predetermined front time t_{F1} of realizing the predetermined front short part of said “drop-shaped” form of said law during the period Tₘ₁ of negative modulating. Accordingly the mean value of amount of sign-alternating vortexes generated by the boundary layer surface during the period Tₘ₁ is negative, as the time t_{B1} of recovery (increase) of pressure ΔPₚₘ₁ in the modulated wave (from ΔPₚₘ₁₍ₘᵢₙ₎ to ΔPₚₘ₁₍ₘₐₓ₎) corresponding to the generation of negative vortexes is more, than the time t_{F1} of decrease of pressure ΔPₚₘ₁ in said wave (from ΔPₚₘ₁₍ₘₐₓ₎ to ΔPₚₘ₁₍ₘᵢₙ₎). Therefore the modulated flow during the average modulation period Tₘ₁ “rolls” on the negative vortexes, losing less energy against the turbulent friction stress on the surface between of boundary layer and nucleus flow. Such, in average (during the modulation period Tₘ₁) a kinetic energy of modulated medium flow Eₖₘ₁ is increased. The above-mentioned analysis have been qualitatively illustrated, for example, by the results of the experimental visual researches of modulated suction air flows, performed by authors. In the modulated air flows a longitudinal “helicoids” vortex it was formed. The similar hydrodynamic phenomenon all the more so can takes place in the more dense fluid media flows (for example, oil or water flows).

Relaminarization of the boundary layer and turbulent nucleus of medium flow is accompanied by suppression of turbulence in these flow zones by modulated pressure waves. The small scale of unsteady vortexes generated by surface of boundary layer are destroyed to around it because of their instability and they not penetrate in the nucleus of flow. That creates the favorable conditions for enlarge of turbulent particles in the flow. Increasing of the streamwise component of turbulent kinetic energy and formation of the ordered longitudinal orientated turbulent structures lead to decrease of the modulated flow turbulent viscosity and to the “pseodolaminarization” of flow. Such dynamic state of turbulence allows to flow in average to maintain the large scale turbulence structure and consequently in average to the optimization maximal increase (on Δ_{Ekm1(max)} for f_{m1(opt)cor}) of the kinetic energy of modulated medium flow from the minimal value Eₖₘ₁₍ₘᵢₙ₎ to the maximal value Eₖₘ₁₍ₘₐₓ₎ (FIG. 8).

The computer simulations, performed by authors, confirmed that a domain of the search of above-mentioned optimal modulation parameters is significantly narrow (see FIG. 5). It can be provided only by the possibilities of dynamic “thin” optimization parametric correction (for example, modulation frequency f_{m1(opt)cor}), for the “resonance” structure-energetically tuning of modulated medium flow process. In this narrow “resonance” domain of changing of the optimal modulation parameters occurs a uniformization of specter of the turbulence modulated medium flow particles. The longitudinal “resonance” movements of said particles lead to significant structure-energetically changes of all pipeline medium flow. Such structure-energetically state of the flow is characterized by maximal interaction of modulated pressure wave with medium flow. Herewith, the maximal value of transformation of modulated pressure wave energy into the medium flow energy and also—significantly decrease of its hydrodynamic resistance is realized, that is a consequences of fundamental restructurization (longitudinal ainizotropization) of nucleus turbulence and boundary layer of modulated medium flow. Therefore, to provide a dramatically minimization of the medium flow transporting energy consumption it is needed to consume for the structure-energetically optimization of modulated medium flow (by said negative modulating of the flow-forming energy action) a significantly less energy, than a energy of the pump constant pressure losses, necessary to provide the same non-modulated medium flow rate. At the predetermined “thin”—optimal modulation parameters of the modulated plane pressure waves of flow-forming energy action the hydrodynamic resistance of pipeline modulated medium flow can achieves near zero value, that in the abstract does not contradict to the physical laws.

At the same time, it is necessary to note that the local longitudinal movements of the fluid particles with sign-alternating acceleration (in the oil flow longitudinal plane “drop-shaped” form waves of modulated flow-forming energy action ΔPₚₘ) near the inner pipeline surface will lead to significant minimization of adhesion process (including paraffin coating of the oil pipeline wall). Beside this, the corrosion and bacterial process will also be minimized in the adhesion layer. Decrease of the adhesion leads to increase of maintain of duration of evenness of pipeline inner surface. The use of modulation of flow-forming energy action allows to decrease the in action value of a modulated pipeline medium flow overpressure ΔP_{pm(act)}. Thus, the mean acting overpressure on the inner pipeline wall will also be significantly (to tens of percents) below than the nominal overpressure, which is used in the modern operating pipeline. The longitudinal oscillations of elementary fluid particles in the modulated turbulent flow practically do not transfer energy to the pipeline wall in the radial direction, because their intensity of the turbulent radial movements is minimized. This leads to decrease of hydrodynamic erosion of an inner pipeline walls. Said oscillations of flow fluid particles also lead to continuous “cleanup” of pipeline inner surface and to prevention of impurity precipitation with further coating formation (for example, paraffin coating of the oil pipeline inner surface). The above-mentioned prevents the possible decrease of pipeline cross-section and, as consequence, the possible increase of energy consumption that could be necessary to maintain the same medium flow pipeline capacity. All of the above-mentioned additional positive modulated energy hydrodynamic effects make more favorable conditions for pipeline operating, predetermine significant increase of the life of pipelines and additionally have influence to the minimization of the specific energy consumption of medium flow pipeline transporting process.

All of for the first above-mentioned physical phenomena, which take place in the modulated turbulent medium flow lead to significant optimization decrease of a value of the hydrodynamic friction coefficient. It can be decreased by the microprocessor-controlled optimization retrieval (for ER_{m1(min)cor}) more than three times. Herewith, a maximal value of optimization decrease of the hydrodynamic resistance of modulated medium flow (and the pump energy consumption relatively) can exceed fifty percent of the value of hydrodynamic resistance of non-modulated medium flow with analogous parameters of the flow transporting system. At the same time (for E_{Rm1(min)cor}), a maximal value of optimization increase of a modulated medium flow rate can also exceed fifty percent of the value of non-modulated medium flow rate. From the above analysis follows that the specific energy consumption of medium flow pipeline transportation process can be decreased more than tree times (at the significant decrease of the time of flow transporting of a given medium volume)—is the hydrodynamic superconductive energy phenomena of the modulated medium flow energy-saving transporting.

The above-mentioned consideration of the unique possibilities of new method of dynamic energy-saving superconductive transporting of medium flow is based on the particular analysis of the operation of the first dynamic subsystem is shown in FIGS. 1 and 2. At the same time said variant of the scheme of functional structure of dynamic transporting system comprising two identical dynamic subsystems. The operation of the above-mentioned second dynamic subsystem is completely analogical to the operation of the first dynamic subsystem. The second dynamic subsystem also provides the energy superconductive (structure-energetically) optimization of the modulated medium flow in the pipeline with analogical modulation parameters: f_{m2(opt)cor}=f_{m1(opt)cor}, bₘ₂₍ₒₚₜ₎=bₘ₁₍ₒₚₜ₎, lₘ₂₍ₒₚₜ₎=lₘ₁₍ₒₚₜ₎ and αₘ₂₍ₒₚₜ₎=αₘ₁₍ₒₚₜ₎, accordingly, realizing by the energy-saving dynamic module 13 connected with the means of medium flow-forming energy action—pump 9 (see FIG. 1). Herewith, also the oil flow longitudinal plane “drop-shaped” form waves of modulated flow-forming energy action ΔPₚₘ₂ in the pipeline, as an independent predetermined periodic process, directly related with the above-mentioned process of modulating the flow-forming energy action ΔPₚₘ₁ in said pipeline (for example—the extended part of pipeline 8).

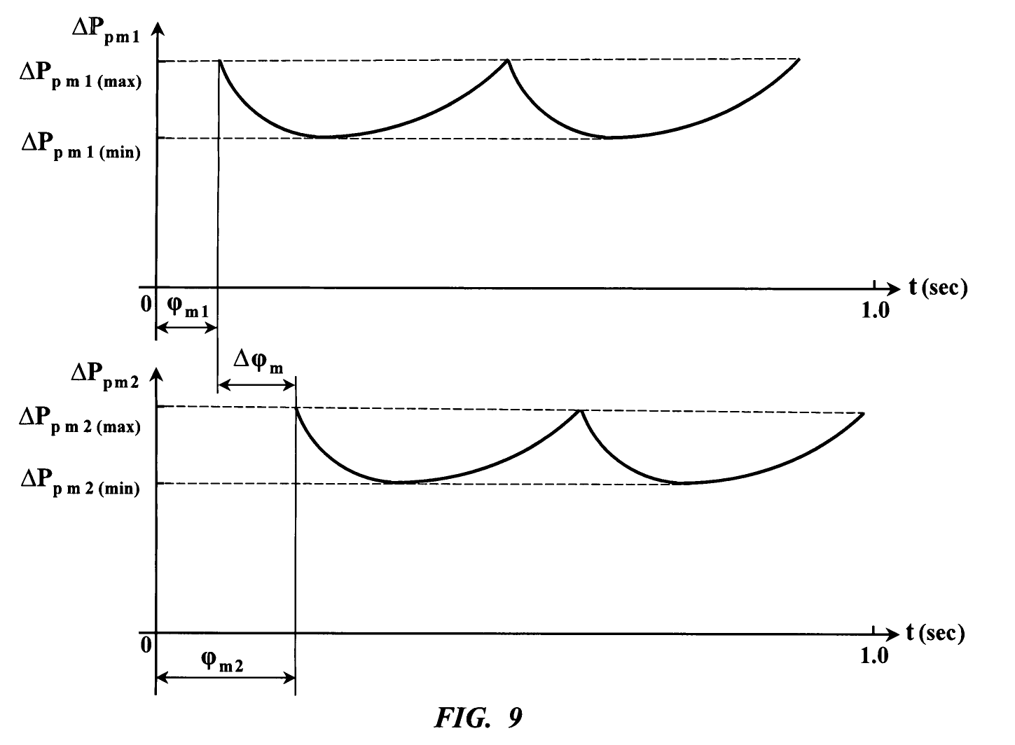

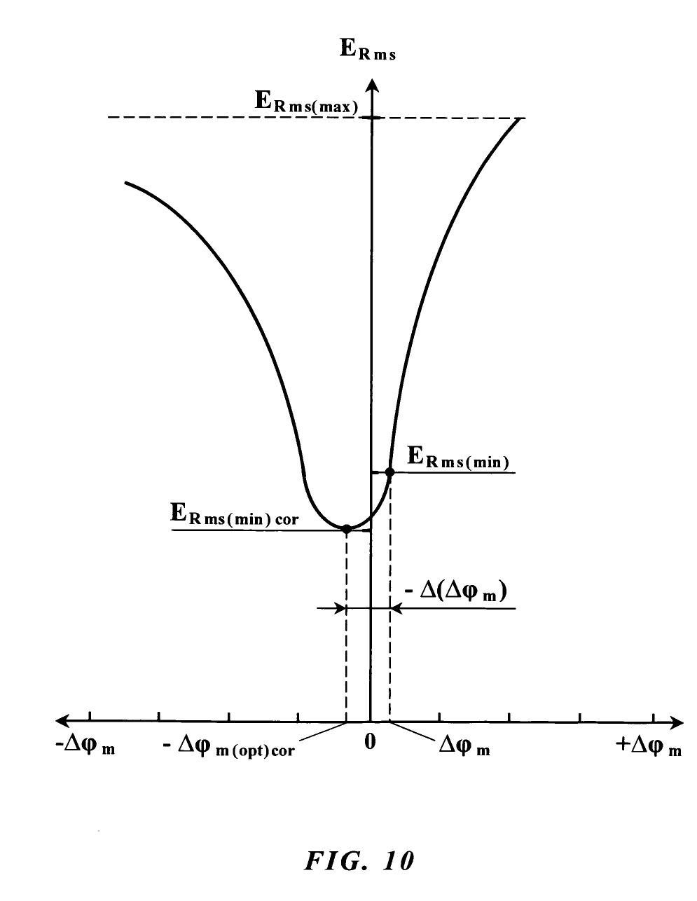

The indicated modulating processes realize the flow-forming energy actions ΔPₚₘ₁ and ΔPₚₘ₂ in said pipeline simultaneously. However, the process of negative modulating of ΔPₚₘ₁ includes providing a predetermined the comparative phase φₘ₁ (given at comparative moment of the switching-on of energy-saving dynamic module 5) and the process of negative modulating of ΔPₚₘ₂ includes providing a predetermined the comparative phase φₘ₂ (given at comparative moment of the switching-on of energy-saving dynamic module 13). Therefore, realization of the modulated flow-forming energy actions ΔPₚₘ₁ and ΔPₚₘ₂ in said pipeline at the start up situation describe the predetermined initial comparative phase shift between said modulated flow-forming energy actions: Δφₘ=φₘ₂−φₘ₁ (FIG. 9). The presence of said initial phase shift Δφₘ at the simultaneous modulated flow-forming energy actions ΔPₚₘ₁ and ΔPₚₘ₂ predetermine negative interference waves energy processes, which reduce the possibility of achievement of a minimal-practicable value of energy optimizing criterion E_{Rms} for the all dynamic transporting systems comprising two identical dynamic subsystems. At said start up situation, when the initial phase shift is Δφₘ, the energy optimizing criterion of the transporting system originally obtains the estimated minimal value of E_{Rms(min)}, significantly discrepant from the practicable value of E_{Rms(max)} (FIG. 10).

The above-mentioned operational energy-saving dynamic modules 5 and 13 providing calculation of an initial real value of energy optimizing criterions (E_{Rm1(min)} and E_{Rm2(min)}) relatively and realizing the microprocessor-controlled optimization retrieval of a minimal-practicable values of E_{Rm1(min)cor} (when the derivative d_{ERm1}/dt=0) and E_{Rm2(min)cor} (when the derivative dE_{Rm2}/dt=0) simultaneously. The achieved dynamic structure-energetically optimization of the all turbulent flow providing the minimal-practicable value of energy optimizing criterion for the all dynamic transporting system E_{Rms(min)cor}, when said predetermined comparative phases φₘ₁ and φₘ₂ are automatically changed at the value of −Δ(Δφₘ) by the energy-saving dynamic module 5 and 13 relatively, to provide a phase shift Δφ_{m(opt)cor} when the value of the derivative dE_{Rms}/dt=0 (see FIG. 10).

The above-mentioned process (for example, in the energy-saving dynamic module 5) of the automatically changing the value of predetermined comparative phases φₘ₁ is realized by the microprocessor control block 16. The sensor 24 and sensor 25 control of the values of technological parameters: V_{f1(act)}, ρ_{f1(act)} and ΔP_{pm1(act)}, incoming in the microprocessor control block 16 for above-mentioned calculation of an initial real value of energy optimizing criterion E_{Rm1(min)cor}, which (at said start up situation) corresponds to the value of E_{Rms(min)}. The microprocessor-controlled optimization retrieval of a minimal-practicable value of E_{Rms(min)cor} providing the change of the estimated value of optimal modulation parameter φₘ₁ until the correction value of φ_{m1cor} by the change of the signal U_{φm1} (to U_{φm1cor}) connected with the drive 22. The signal U_{φm1} of (for example) the impulse form with the parameters: amplitude, sign, form and duration, optimization changing by the microprocessor control block 16 during of the optimization retrieval of a minimal-practicable value of E_{Rms(min)cor}. The present impulse signal U_{φm1} provides of the impulse braking (or accelerating) of the rotation of the drive 22 of the movable cylindrical valve element 20, that impulse optimization retrieval of the value of φ_{m1cor}. The optimization retrieval of the value of φ_{m2cor} in the energy-saving dynamic module 13 providing reciprocally and simultaneously with above-mentioned optimization retrieval of the value of φ_{pm1cor}, that predetermines the system optimization retrieval of the minimal-practicable (superconductive) value of E_{Rms(min)cor}.

The proposed (at the first time) phase automatic control of the negative modulating of flow-forming energy actions providing the qualitatively new possibility for the energy-effective structure-energetically (superconductive) optimization in the similar multi-pumps (consecutive or parallel connected with pipeline) system dynamic medium flow processes by changing a value of at least one said modulation parameter in dependence on a change of a value of at least one the controlled technological characteristic.

The above-mentioned predetermines the possibility of the extensive use of the proposed new method of dynamic energy-saving superconductive transporting of medium flow in various fields of the energy-consuming flow pipeline transportation market, covered (for example) the transport, industry, military, environment, medical, household, and will including the different groups of dynamic pipeline transportation systems of the total length in tens of millions of miles (existing systems, which will equip the energy-saving dynamic modules and new dynamic systems):
Dynamic local pipeline transportation systems (for example: air purification and conditioning; heat and mass exchangers; fuel or/and water supply; different flowable media loading; physiological media; etc);
Dynamic industrial pipeline transportation systems (for example: different technological materials—granules, powders, chemical and gas components, etc; petroleum products; natural gas; fluid materials and excavated products; fuel; water; heat and mass exchangers; air purification and conditioning; tankers; etc);
Dynamic network pipeline transportation systems (for example: water; natural gas; etc);
Dynamic trunk pipeline transportation systems (for example: water; natural gas; crude oil; fluidized coal, minerals and ores; etc).

For example, using of the new development dynamic energy-saving superconductive medium flow pipeline transporting process in the traditional oil loading/unloading tanker pumping systems will provide the considerable increase (about twenty-forty percentages) of the oil flow velocity (pipeline capacity) and considerable decrease (about two-three times) of the specific energy consumption. Herewith, it will provide the considerable decrease (about thirty percentages) of the time of oil loading/unloading process and the cost of tanker terminal stay, and well then—significant increase of economic and exploitation efficiency of the exploitation of port terminals and tankers fleet. The similar use of the energy-saving medium flow pipeline transporting process in the air refueling of aircrafts will lead to analogical decrease of the refueling time, energy consumption, and also—sizes and weight of the aircrafts pumping system.

The energy-saving dynamic modules of the similar dynamic pipeline transportation systems can have different schematic, structural and functional solutions. One of the possible variants of the functional construction of the valve block of the energy-saving dynamic module, which is a new so-called “hollow shell” variant, is shown in FIG. 2 and can be a universal schematic solution for producing dynamic modules for different applications. General various variants of the construction of the modulating valve block and various algorithms of operation of the compact intellectualized energy-saving dynamic module are described in detail, for example in the above-mentioned our U.S. patents. At the same time it is necessary to note that the realization of the new method of dynamic energy-saving superconductive transporting of medium flow in the various application can relate with need of the specific changes in the operation of the microprocessor control block, valve block or/and sensors control of the technological parameters.

The above-mentioned microprocessor control block of the functional structure of energy-saving dynamic module (for example, as the block 16 of module 5 in FIGS. 2) can include:
the above-mentioned so-called “drop-shaped modulating hydrodynamical model of Relin-Marta”, integrated in operation algorithm of this block for providing of universal parametric functionality by the possibility of the automatic correction of the computer estimated optimal modulation parameters at entry in the block of a new given parameters of pipeline system, modulated medium flow or/and flow medium, and also—controlled current optimization parameters of modulated medium flow or/and flow medium;
the additional discrete inputs for setting of the new given parameters of pipeline system, modulated medium flow or/and flow medium;
the additional optimization parametric inputs for setting of the new controlled current optimization parameters of modulated medium flow or/and flow medium;
the additional controlling outputs, which are connected for example, with the specifics channels of the multi-channel valve block or/and with the additional drive for movement of the above-mentioned control (ring) element for needed complex correction of computer estimated optimal modulation parameters of the cylindrical valve elements of the valve block.

The microprocessor control block can realize various algorithms of a single- and multi-parameter optimization control of the parameters of the modulation for providing a single- or multi-parametric optimization of the process of dynamic energy-saving superconductive medium flow transporting. For providing the special technological requirements can use the optimization algorithm including the maintenance of given controlled in action value of modulated medium flow velocity and to provide a minimal value of energy ratio E_{Rm(min)} simultaneously.

The additional controlling output, which are connected with the additional drive for movement of the above-mentioned control (ring) element can be connected, for example, with an electromagnetic drive providing the possibility of the given linear displacement or given angular displacement of the control (ring) element for needed complex correction of the above-mentioned computer estimated optimal modulation parameters (bₘ₍ₒₚₜ₎, lₘ₍ₒₚₜ₎ and αₘ₍ₒₚₜ₎) of cylindrical valve elements of the valve block.

The multi-channel valve block can include the longitudinal (coherent) disposition of several sectional cross-sections of the passing channels, which are formed (simultaneously, alternatively or selectively, for example by the movable control element) during the rotation of the movable cylindrical valve element relative to the immovable cylindrical valve element. Other of the possible variants of the functional construction of the multi-channel valve block of the energy-saving dynamic module can include the parallel disposition of several above-mentioned “longitudinal” single- or multi-channel switch movable valve couples, including the movable and immovable cylindrical valve elements, and also—controlling drive, each. In some schematic solutions of the valve block the independent control (ring) element can be excluded. The functional role of this element can be carried out for example either by a structure of the immovable cylindrical valve element, which can be movable in the longitudinal and angular directions, or by a structure of the movable cylindrical valve element, which can be movable in the longitudinal direction (possibly with its drive). Herewith, said selective several sectional cross-sections of the passing channels of the multi-channel valve block can provide the different complex of the modulation parameters (lₘ, bₘ, αₘ and Tₘ) for realization of the microprocessor-controlled optimization retrieval of a minimal-practicable values of E_{Rm(min)}.

The above-mentioned different additional functional and technical possibilities of the microprocessor control block and valve block can provide the change of the value of time ratio αₘ (as an additional predetermined modulation parameter of said negative modulating) in dependence on a change of a value of at least one a characteristic connected with said dynamic medium flow process to provide a minimal value of energy ratio E_{Rm(min)}. Such changes of said value of time ratio during the realization of predetermined period Tₘ of said “drop-shaped” form of said modulation law can include:
the technical changing a predetermined front time t_{F} and providing a predetermined period Tₘ of said negative modulating simultaneously;
the technical changing a predetermined period Tₘ of said negative modulating and providing a predetermined front time simultaneously;
the technical changing a predetermined front time t_{F} and a predetermined period Tₘ of said negative modulating simultaneously.

The above-mentioned realization of the automatic control of predetermined phase φₘ of negative modulating of flow-forming energy actions can use and the different various technical solutions, for example:
the turn of the immovable cylindrical valve element of the valve block on given corner by the stepping motor;
the turn of the body of drive of movable cylindrical valve element on given corner by the stepping motor;
the turn of the movable cylindrical valve element on given corner by the stepping motor (or selsyn motor), which use as its drive; etc.

The above-mentioned controlled in action value of said modulated medium flow-forming energy can be evaluated by use, for example: a controlled in action value of a modulated medium flow pressure, providing of said means of medium flow-forming energy action (pump); or a controlled in action value of at least one a energy parameter, connected with a value of energy consumption of said means of medium flow-forming energy action (drive of the pump).

At the same time, the above-mentioned controlled in action value of said formed kinetic energy of said modulated medium flow can be evaluated by use, for example: a controlled in action value of a modulated medium flow velocity and a predetermined value of a flow medium density; or a controlled in action value of a modulated medium flow velocity and a controlled in action value of a flow medium density.

The above-mentioned energy-saving dynamic module, which realizes the principle of controlled inner dynamic shunting of working zones of the pump, can be parallel connected with the means of medium flow-forming energy action, including only one the pump or including the compact multi-pumps (consecutive or parallel connected with pipeline) system. At the same time, for example in the air flow pipeline transporting systems can use the energy-saving dynamic module, which realizes the principle of controlled exterior dynamic shunting of a selected portion of a modulated suction air flow, connected with a suction working zones of said means of air flow-forming energy action. In the same medium flow pipeline transporting systems can be used the both variants of above-mentioned energy-saving dynamic modules simultaneously, and the realizable (in these both variants) dynamic shunting includes providing a controlled predetermined dynamic periodic connection of the modulated suction medium flow with modulated shunt medium flow, realizing around of said modulated suction medium flow. Besides, the new method makes possible a realization of one of several main variants of said negative modulating a value of the medium flow-forming energy action includes providing the controlled predetermined dynamic periodic change of a value of at least one a parameter, dynamically connected with process of a conversion of a consumption energy to said modulated medium flow-forming energy action realizable in said means (for example, pump) of medium flow-forming energy action (are described in detail, for example in the above-mentioned our U.S. patents).

The above-mentioned supereffective use of the proposed new method of dynamic energy-saving superconductive transporting of medium flow in the dynamic transporting system (comprising two identical dynamic subsystems) is the example of realization of the modulated medium flow superconductive transporting in combination with the above-mentioned independent predetermined periodic process can include the modulating a value of a medium flow-forming energy action of an additional means of medium flow-forming energy action directly connected with said modulated medium flow (the object of energy action) in the common pipeline, which is the action working zone.

At the same time, the above-mentioned new method can also energy effective be used and in the different various technological applications, when the above-mentioned independent predetermined periodic process can include providing the modulating a value of a medium flow-forming energy action of at least one an additional means of medium flow-forming energy action connected with said modulated medium flow at least one a medium flow action working zone including at least one a medium flow action object. And besides, the above-mentioned medium flow action working zone can include, for example at least one a perforating admission to provide of a perforated medium flows, and the above-mentioned medium flow action object can be, without any limitation, for example: the object of porous, filter or constructive structure; the porous medium saturated object or the specific detection object.

The demonstrative examples of the similar technological applications can be, without any limitation, the different various methods and systems of dynamic superconductive energy optimizing of perforated medium flows action, which can be based on the realization of the above-mentioned new proposed modulation method. The known similar perforated medium flows action system comprises at least one a perforated medium flows action unit including at least one a means of medium flow-forming energy action, at least one a medium flow suction pipeline or/and at least one a medium flow power pipeline with at least one a action perforated part. And besides, an exterior surface of said action perforated part connected with at least one a medium action working zone including at least one a medium action object. Herewith, the above-mentioned method of energy optimizing (realizing for example, by use of at least one the above-mentioned energy-saving dynamic module) can comprises the modulating a value of said medium flow-forming energy action of at least one said means of at least one said unit and also—above-mentioned optimization changing a value of at least one a parameter of said modulating in dependence on a change of a value of at least one a characteristic connected with a medium flows action process realizable in said medium action working zone to dynamic space-temporal structure-energetically optimize, in a energy-effective manner, said medium flows action process.

The above-mentioned systems of dynamic superconductive energy optimizing of perforated medium flows action can using in the different technological applications, without any limitation, for example:
the oil extraction technology by dynamic forcing of oil from the bed porous structure (or from the oil bed bank) using the dynamic multijets injection of perforated medium action flows (for example, water, gas or mixtures) through perforated casing of injection well to action working zone of porous medium saturated with oil (or to action working zone of oil bed bank);
the oil extraction technology by dynamic suction of oil from the bed porous structure (or from the oil bed bank) through production well perforated casing adjacent to action working zone;
the gas extraction technology by dynamic suction of gas from the bed porous structure (or from the gas bed bank) through production well perforated casing adjacent to action working zone;
the water extraction technology by dynamic suction of water from the bed porous structure (or from the water bed bank) through production well perforated casing adjacent to action working zone;
the uranium extraction technology by dynamic forcing of uranium from the bed sandstone (or ore body) porous structure using the dynamic multijets injection of perforated medium action flows (for example, water plus oxygen) through perforated casing of injection well to action working zone of porous medium saturated with uranium;
the uranium extraction technology by dynamic suction of uranium from the bed sandstone (or ore body) porous structure through production well perforated casing adjacent to action working zone;
the chemical substances catalysis technology by use perforated medium flows action on the catalytic action working zone of chemical reactor;
the cleaning and coating technologies by use perforated medium flows action on the movable (or immovable) action object in the action working zone;
the operational detection technologies by use perforated medium flows action on the movable (or immovable) action object in action working zone, wherein simultaneously with said characteristics connected with a medium flows action process additionally control at least one a specific detection space-geometrical, structural, physical and/or chemical parameter of said medium action working zone and/or said medium action object or a part of said medium action object; etc.

In the process of realization of the new dynamic method of energy optimizing in the above-mentioned dynamic energy-saving systems can be used said technological characteristics connected with said medium flows action process and selected from the group consisting of (but not limited): a energy consumption of said means of medium flow-forming energy action (for example, a pump energy consumption); a pressure, a temperature and/or a rate of said medium flow; a space-geometrical, structural, physical and/or chemical parameters of said medium action working zone and/or said medium action object; a energetically, rate, velocity parameters of said medium action object; a dynamic energetically parameters of at least one other means of medium flow-forming energy action on said medium action object (for example, a other pump energy consumption); and also—a frequency, a range, a law, and/or comparative phase of said other modulated medium flow-forming energy action.

It should be noted, that said modulated perforated power medium flow—so-called a “exterior” flow (for example, pressing in water flow) and said modulated perforated suction medium flow—so-called a “interior” flow (for example, stamping oil flow) in said medium flow action working zone (for example, oil saturated porous structure) are across connected between them. This provides the possibility of control optimization of a value of predetermined comparative phase shift between the predetermined comparative phases of said modulations of said exterior and said interior medium flows will provide, in the average (during the modulation period Tₘ), a maximal fluidity of said oil flow and its maximal rate.

Besides, said changing a value of at least one a parameter of said negative modulating (with the use of the proposed phase automatic control, medium flow longitudinal plane “drop-shaped” form waves of modulated flow-forming energy action and energy optimizing criterion) includes providing a maximal efficiency of a complex medium flow-forming energy action on said medium action object and a minimal value of a complex energy consumption during said medium flows action process, simultaneously—superconductive energy regime. Herewith, said superconductive energy regime of said medium flows action process includes the optimizing of dynamic modulating turbulent structure and energy of said medium flows action to provide, in a energy-effective manner, maximal dynamic energy of said modulated medium flows action on said medium action object and provides a structure-energetically ‘resonance’ respond of a medium action object system by optimization of a dynamic parameters of said modulating.

The above-mentioned new systems of dynamic superconductive energy optimizing of perforated medium flows action, realizing the proposed new modulation principles of the energy optimization of perforated modulated medium flows energy action process, can provide the following qualitatively new advantages, for example:
provides a significant decrease (more two times) of energy consumption by dynamic multijets perforated injection medium flows action on the medium action working zone adjacent to action perforated part of medium suction (or power) pipeline of the dynamic perforated medium flows action system;
provides a significant decrease (more two times) of hydrodynamic resistance of medium flow suction (or power) pipeline and its perforated cannels;
provides a significant decrease of adhesion on the interior surface of the medium flow suction (or power) pipeline and perforated cannels that lead to significantly increase their life time;
provides a dynamic perforated medium flows action on the action working zone;
provides a continuous energy action of modulated plane pressure waves on the action working zone, that lead to movements of elementary fluid particles of medium flow with sign-alternating acceleration (for example, oil flow in bed porous structure); herewith, these particles movements lead to decreasing of adhesion processes in the bed pores, prevent their blocking (effective dynamic antiblocking process), maintain the pores in open state and lead to decreasing of the pore hydrodynamic resistance; at the same time, the movements of elementary fluid particles of heterogeneous medium flow with sign-alternating acceleration lead to medium “loosening” and consequently increasing its fluidity (for example, oil);
provides a significant increasing (about 1.5-2 times) of medium flow rate from bed porous structure in the action working zone (for example, oil or uranium ore) under the minimal total energy consumption—superconductive energy regime;
provides a significant increase (about 1.5-2 times) of a velocity displacement of medium from the bed porous structure of action working zone (for example, oil or uranium ore);
provides more wide possibilities of optimization of technological process (suction or replacement) by use a control of different its characteristics for one or many perforated medium flows action units in the system;
provides a maximal using of possibilities of exploitation traditional perforated medium flows action systems by only additionally use of the energy-saving dynamic module, realizing of said modulation a value of said medium flow-forming energy action of at least one said means of at least one said perforated medium flows action unit.

The others demonstrative examples of the similar technological applications can be, without any limitation, the different various methods and systems of dynamic superconductive energy optimizing of treatment/filtering, which based on the realization of the above-mentioned new proposed modulation method. The known similar filtering system for providing of a carrying medium flow treatment/filtering process (for example, wastewater filtering system), comprises at least one a means of flow-forming energy action (for example, pump) on a suction or/and pressure pipelines and at least one a treatment/filter block. Herewith, the above-mentioned method of energy optimizing (realizing for example, by use of at least one the above-mentioned energy-saving dynamic module) can comprises the modulating a value of said carrying medium flow-forming energy action of at least one said means and also—above-mentioned optimization changing a value of at least one a parameter of said modulating in dependence on a change of a value of at least one a dynamic treatment/filtering process characteristic for dynamic structure-energetically optimization, in a energy-effective manner, the carrying medium flow treatment/filtering process.

The development above-mentioned new class of different dynamic energy-saving superconductive medium flow treatment/filter systems, which will provide the dynamic superconductive energy optimizing of the carrying medium flow treatment/filtering process, can be use in various technological applications, without any limitation, for example in water treatment/filtering industry:
dynamic water depth microporous pressure filter systems;
dynamic water screen microporous pressure filter systems;
dynamic water ultra fine pressure filter systems;
dynamic water GAC pressure treatment systems;
dynamic water gravity filter systems;
dynamic managed air systems (for the cleaning of water filter block), etc.

Besides, the similar dynamic superconductive energy-saving medium flow treatment/filter systems can be developed also and for different super treatment/filtering technological processes, without any limitation, for example: media, cartridge, membrane filtration, reverse osmosis, carbon adsorption, ultraviolet and chemical disinfections, and also—aerobic biological technological processes.

The optimization changes of a value of at least one a parameter of said negative modulating (with the use of proposed phase automatic control, medium flow longitudinal plane “drop-shaped” form waves of modulated flow-forming energy action and energy optimizing criterion) includes providing a regime of a maximal energy-filtering quality efficiency of the complex carrying medium flow-forming energy action on said treatment/filter block (a minimal value of a complex energy consumption during the carrying medium flow treatment/filtering process) and maximal treated/filtered carrying medium flow rate, simultaneously—superconductive energy flow treatment/filtering regime. It should be noted, that said modulated carrying wastewater flow and modulated treated/filtered carrying water flow are across connected between them in the filter/treatment block and controlling independently. This creates the possibility of control optimization of a value of predetermined comparative phase shift between the predetermined comparative phases of said modulations of said wastewater and said treated/filtered carrying water flows will provide, in the average (during the modulation period Tₘ), a maximal volume fluidity of said water flow in filter/treatment block and a maximal treated/filtered flow rate.

Herewith, the medium flow longitudinal plane “drop-shaped” form waves of modulated flow-forming energy action, are spreading through said pipeline different carrying medium flows and the treatment/filter block structures. It provides a structure-energetically ‘resonance’ respond of the medium action object—treatment/filter block structure by optimization of the dynamic parameters of said modulating and predetermine of a minimization its blocking in accordance with, that first realizable new dynamic untiblocking mechanism provides, without any limitation, for example:
the continuous prevention of a cake stabilized form and a maintaining of “dynamic-breathing” treatment/filter block structure cake in the loosened—porous state;
the minimization of probability of cluster formation and a minimization of fluid particles settle on said treatment/filter block structure;
the minimization of probability of impurity particles settle inside of a treatment/filter block structure pores and a increase of fluidity through said structure;
the minimization of probability of beginning of one-layer cluster formation on a treatment/filter block structure surface.

The above-mentioned new dynamic energy-saving superconductive medium flow treatment/filter systems, realizing the proposed new modulation principles of the energy optimization of the different carrying medium flow treatment/filtering process, will provide the following qualitatively new advantages, for example:
the essentially better quality of treatment/filtering process as compared to any exiting modern technology in this field;
the essential increase (about two times) of treatment/filtered medium flow productivity for any existing and new dynamic medium flow treatment/filter systems;
the essential decrease (about 1.5-3.0 times) of specific energy consumption by treatment/filtering process;
the improvement of operational characteristics of any existing and new dynamic medium flow treatment/filter systems including the minimization of treatment/filtering system channels congestion (e.g. the rise in the durability of downtrodden medium flow pipelines);
the new dynamic possibilities of micro-structure influence on the blocking mechanisms inside the structure of the system treatment/filter block—new dynamic untiblocking mechanisms;
the creation of qualitatively new dynamic possibilities to automatic multi-parametric optimization of dynamic medium flow filtering, treatment and managed processes;
the local longitudinal movement of the carrying medium flow fluid particles with sign-alternating acceleration near a inner pipelines surface will lead to significant minimization of adhesion, corrosion and bacterial processes inside of the all components of the treatment/filter systems, that will predetermine the extra possibilities of improvement of medium flow treatment/filter quality;
the significant decrease of pressure on the inner pipeline wall and treatment/filter system components, provides more comfortable regime exploitation of dynamic treatment/filtering systems; the significant increase of life time of dynamic treatment/filtering systems;
the essential decrease of specific expenses in conjunction with medium flow purification process.

Said factors predetermine more efficiency of the energetic and exploitation characteristics of new dynamic superconductive energy-saving superconductive medium flow treatment/filter systems, which will revolutionize a wide range of applications in the numerous medium flow treatment/filter fields. Furthermore, the possibility of development of various compact modern dynamic components (energy-saving dynamic modules) allows re-equipping with them the existing treatment/filter systems as well as to utilize them in newly developed dynamic systems.

The above-mentioned demonstrative examples of the two massive new class of different dynamic energy-saving superconductive medium flow technological systems is only small part of the wide classification group of new development similar dynamic energy-saving systems, which provide of “supereffective” dynamic flow action on the object and cover, without any limitation, for example:
the dynamic vacuum cleaning systems (manual, build in, mechanized and special, example—underwater);
the dynamic medical suction systems and instruments (surgical, dental, liposuction, testing, gynecological, massaging procedures, etc.);
the dynamic pumping systems (treatment or cleaning of object surfaces);
the dynamic systems for selection of small objects;
the dynamic suction mineral concentration systems (gold, coal, uranium, etc.);
the dynamic vacuum systems for forming of mixtures;
the dynamic dusting systems;
the dynamic systems for special usage (dynamic suction/power systems for detection of components on the moving objects); and etc.

The others complex demonstrative examples of the similar technological applications can be, without any limitation, the different various methods and systems of dynamic energy-saving superconductive flow heat transferring, which based on the realization of the above-mentioned new proposed modulation method. These new dynamic systems realizing the complex of two energy optimization tasks: the above-mentioned dynamic medium flow pipeline transporting and dynamic medium flow action on the object—thermal boundary layer of said dynamic medium flow. The known similar flow heat transferring system for providing of a heat transferring process (for example, heat transferring system for gas liquefaction), comprises, for example, at least one a means of heat transfer medium flow-forming energy action (for example, pump); at least one a supply pipeline and at least one a bend pipeline for transporting of heat transfer medium flow; at least one a heat exchanger including at least one a flow heat transfer canal for an interior heat transfer medium flow, disposed inside of heat exchanger shell containing an exterior heat transfer medium circumfluent out of said canal. Herewith, the above-mentioned method of energy optimizing of said heat transfer process (realizing for example, by use of at least one the above-mentioned energy-saving dynamic module) can comprise the modulating a value of said heat transfer medium flow-forming energy action of at least one said means and also—above-mentioned optimization changing a value of at least one a parameter of said modulating in dependence on a change of a value of at least one a technological characteristic connected with a energy efficiency of said heat transfer process, for dynamic structure-energetically optimization, in a energy-effective manner, the flow heat transfer process.

The development above-mentioned new class of different dynamic energy-saving superconductive flow heat transferring systems, which will provide the dynamic superconductive energy optimizing of the heat transfer medium flow process, can be used in various technological applications, without any limitation, for example:
the flow heat transferring processes in chemical industry (for instance, petroleum refining and petrochemical processing);
the generation of steam for production of power and electricity;
the nuclear reactor systems;
the field of cryogenics (for instance, low-temperature separation of gases and gases liquefaction);
the flow heat transfer at a liquid vaporization;
the flow heat transfer at a steam condensing;
the food industry (for instance, for pasteurization of milk and canning of process foods);
the aircraft and vehicles;
the heating, ventilating, air conditioning and refrigeration; etc.

In the process of realization of the new dynamic method of energy optimizing in the above-mentioned dynamic energy-saving superconductive flow heat transferring systems can used said technological characteristics connected with the energy efficiency of said heat transfer process and selected from the group consisting of (without any limitation): a energy consumption of said means of medium flow-forming energy action (for example, a pump energy consumption); a dynamic energetically parameters of at least one other an additional means of medium flow-forming energy action (for example, a other pump energy consumption into a “double-canal” heat exchanger) and also—a frequency, a range, a law, and/or comparative phase of said other an additional modulated medium flow-forming energy action, for example into the “double-canal” flow heat exchanger; temperature of said interior heat transfer flow medium; a temperature of said exterior heat transfer flow medium; an interior heat transfer medium flow rate; an exterior heat transfer medium flow rate; a heat transfer flux; etc.

At the realization of the method of energy optimizing, wherein a flow heat exchanger is flow heat exchanger of the type “double-canal” (for example, “double-pipe”) said modulating a value of at least one said interior heat transfer medium flow-forming energy action and said additional modulating a value of at least one said exterior heat transfer medium flow-forming energy action will provide simultaneously. Herewith, said both modulating includes providing a predetermined comparative phase shift of said modulations, which can change by the changes of a phase at least one of said modulating during said flow heat transfer process in dependence on a change of value at least one of above-mentioned characteristic. In these case, said additional modulating a value of at least one said exterior heat transfer medium flow-forming energy action is the independent predetermined periodic process constructive connected with modulated interior heat transfer medium flow. The possibility of the optimization control of a predetermined comparative phase shift between the predetermined comparative phases of said modulations of said exterior and said interior heat transfer medium flows will provide, in the average (during the modulation period Tₘ), a minimal value of a thickness of a thermal boundary layers along the all heat exchange surface, and also—a maximal value of the heat flux (for example, on the surfaces of “double-pipe” of said flow heat exchanger of the type “double-canal”).

Besides, said changing a value of at least one a parameter of said negative modulating (with the use of proposed phase automatic control, medium flow longitudinal plane “drop-shaped” form waves of modulated flow-forming energy action and energy optimizing criterion) includes providing a regime of a maximal value of a heat transfer flux and a minimal value of a complex energy consumption during the heat transfer medium flow process, simultaneously—superconductive flow heat transferring energy regime. Herewith, medium flow longitudinal plane “drop-shaped” form waves of modulated flow-forming energy actions are spreading through said heat exchanger pipelines (“double-pipe”) and provide a structure-energetically ‘resonance’ respond of the medium action object—“double thermal boundary layer” of said dynamic medium flows double structure by optimization of the dynamic parameters of said modulations.

The above-mentioned new dynamic energy-saving superconductive flow heat transferring systems, realizing the proposed new modulation principles of the energy optimization of the different heat transfer medium flow process, will provide the following qualitatively new advantages, for example:
the continuous action of a mechanism of hydrodynamic instability progress of the surface of boundary layer of turbulent heat transfer medium flows (new method of the dynamic control of boundary layer);
the form of pressure “standing wave” (“virtual turbulator”), which lead to dynamic wave-deformation of structure of hydrodynamic and thermal boundary layers and minimization of their thickness;
the minimize of the energy losses in the heat transfer medium flows due to modulated optimization of parameters of elementary fluid particles (for example: dimension, density, viscosity, and their amplitude-frequency characteristics);
the “resonance” energetically self-organization of turbulence structure of heat transfer medium flows;
the maximal value of a turbulent heat flux to the canal wall of heat exchanger;
the significant minimization of all fouling mechanisms of a heat transferring surface (for example: crystallization, sedimentation, coking, corrosion, etc.) and also—decrease of adhesion and bacterial actions on the heat transferring surface;
the significant increase of heat transferring coefficient on the heat transfer surface;
the decrease of requisite heat transfer medium flow rates (interior and exterior), and so—decrease of pumping energy consumption;
the significant decreases of specific energy consumption of flow heat transferring process in the heat exchanger;
the significant increase of a value of vaporization process velocity of a heat transfer liquid flow;
the significant increase of a value of velocity of a heat transfer gas flow in liquefaction process;
the significant increase of a value of a heat transferring coefficient during the processes of vaporization and condensation, for example, in the air-conditioning systems;
the significant decreases of a size and weight of flow heat transferring and air-conditioning systems;
the increase of life time of flow heat transferring and air-conditioning systems; etc.

The above-mentioned factors predetermine more efficiency of the energetic and exploitation characteristics of new dynamic energy-saving superconductive flow heat transferring systems, which will allow revolutionize a wide range of applications in the numerous flow heat transferring fields. Furthermore, the possibility of development of various compact modern dynamic components (energy-saving dynamic modules) also allows re-equipping with them the existing flow heat transferring systems as well as to utilize them in newly developed dynamic flow heat transferring systems.

The other demonstrative examples of new development dynamic energy-saving superconductive medium flow technological systems include the wide classification group of the new class of different similar energy-saving systems, which provide of “supereffective” spatial structure of outside flow working zone and covered, without any limitation, for example:
the dynamic fuel systems for different types of engines (internal-combustion engines, turboreactive engines, reactive engines, etc.);
the dynamic fuel systems for different types of stoves (industrial, household and special usage);
the dynamic fuel systems of gas turbines for production of electricity;
the dynamic dosing components systems (controlling of chemical reactions in different technological processes);
the dynamic dosing systems for special usage (plasma systems for dusting materials, aero- and hydro-acoustic generators, etc.).

The example of similar dynamic technological applications can be, without any limitation, the different various methods and systems of dynamic energy-saving superconductive flow burning, which based on the realization of the above-mentioned new proposed modulation method. These new dynamic systems realizing the complex of two energy optimization tasks: the above-mentioned dynamic medium flow pipeline transporting and dynamic medium flow spatial structure in the burning working zone (outside flow pipeline zone). The known similar flow burning system comprises, for example, at least one a means of non-injected and/or injected fuel (or at least one combustibles component) flow-forming energy action (pump); at least one a suction pipeline and at least one a power pipeline for transporting of said fuel (or at least one combustibles component) flow in at least one the working burning zone. Herewith, the above-mentioned method of energy optimizing of said flow burning process (realizing for example, by use of at least one the above-mentioned energy-saving dynamic module) can comprise the modulating a value of said fuel flow-forming energy action of at least one said means and also—above-mentioned optimization changing a value of at least one a parameter of said modulating in dependence on a change of a value of at least one a technological characteristic connected with the flow burning process realizable in said burning zone, for dynamic structure-energetically optimization, in a energy-effective manner, of the flow burning process.

In the process of realization of the new dynamic method of energy optimizing in the above-mentioned dynamic energy-saving superconductive flow burning systems can be used said technological characteristics connected with the energy efficiency of said flow burning process and selected from the group consisting of (without any limitation): a energy consumption of said means of medium flow-forming energy action (for example, a pump energy consumption); a dynamic energetically parameters of at least one other an additional means of medium flow-forming energy action and also—a frequency, a range, a law, and/or comparative phase of said other an additional modulated medium flow-forming energy action; a pressure, a temperature and a rate of said non-injected and/or injected at least one combustibles component (or fuel) flow; a combustible (or fuel) purity; a burning temperature into a combustion chamber; a moment, a duration and a law of an injected at least one combustibles component (or fuel) injection; the energetically parameters, a moment, a duration and a law of a combustibles component (or fuel) ignition into said combustion chamber; a space-temporal fire parameters; a flame spread velocity; a combustible ignition temperature; a degree of burning a physical and/or chemical parameters of a exhaust combustion products (mostly, for example, a carbon dioxide, toxic gases and water); etc.

In these cases of the realization of the method of energy optimizing, for example, the fuel (or combustibles component) flow periodic injection (in said burning zone) process is the independent predetermined periodic process, which constructive connected with modulated pipeline fuel (or combustibles component) flow. Herewith, said both dynamic processes includes providing a predetermined comparative phase shift between a predetermined phases of said modulating and said periodic injection, which can be changed by the changes of phase of said modulating pipeline fuel (or combustibles component) flow during said flow burning process in dependence on a change of value at least one of above-mentioned characteristic. The possibility of optimization control of said predetermined comparative phase shift allows to set and to maintain in the average (during the modulation period Tₘ) of the dynamic superconductive energy-effective state of fuel (or combustibles component) flow spatial structure in the burning zone.

Besides, said changing a value of at least one a parameter of said negative modulating (with the use of proposed phase automatic control, medium flow longitudinal plane “drop-shaped” form waves of modulated flow-forming energy action and energy optimizing criterion) includes providing a regime of a maximal value of a burning heat and a minimal value of a general combustibles component (or fuel) consumption during said flow burning process, simultaneous

superconductive flow burning energy converting regime. Herewith, the modulating of combustible mixture flow in said power pipeline lead to the uniform distribution of combustibles components to the all cross section of said combustible mixture flow. The injection of said modulated combustible flow in said burning working zone makes the favorable conditions for its burning by the significant intensification of said modulated burning process, providing the more high degree of fuel burning, and so—minimization of the flame length. Herewith, fuel flow longitudinal plane “drop-shaped” form waves of modulated flow-forming energy actions spreading through said flow burning system pipelines and said flow burning zone, providing a structure-energetically ‘resonance’ respond of the all medium structure action object by optimization of the dynamic parameters of said modulation. Said structure-energetically ‘resonance’ respond of turbulent structure and geometry of a dynamic space-temporal burning working zone will provide, in a burning-energy effective manner, maximal velocity and maximal full of said general combustibles component (or fuel) combustion, which cover all the phases of a fire (includes a laminar and turbulent burning).

In the different cases of the realization of the method of energy optimizing said modulating can include the exterior modulating process, which realizes a principle of controlled exterior dynamic shunting of a selected portion of said suction fuel pipeline, and provides a modulating connection of a suction pipeline interior cavity with at least one a non-injected and/or injected combustibles component (or fuel), simultaneously to optimize a dosage and a dynamic space-temporal mixing of different said combustibles components and said transporting fuel (or at least one combustibles component) flow in said fuel suction and power pipelines. Besides, with said interior modulating process a dependent exterior modulating process can be used simultaneously. Herewith, said dependent exterior modulating will realize a principle of controlled exterior dynamic shunting of a selected portion of said suction pipeline and provides a modulating connection of a suction pipeline interior cavity with at least one a non-injected and/or injected combustibles component (or fuel), simultaneously to binary optimize a dosage and a dynamic space-temporal mixing of different said combustibles components (or fuel) and said transporting fuel (or at least one combustibles component) flow in said suction and power pipelines. Herewith, said exterior modulating process can include providing a predetermined at least one parameter of said exterior modulating selected from the group consisting of: a frequency, a range, a law and comparative phase shift of said dependent modulating; comprises an exterior modulation discrete input and an optimization parametric input. The exterior modulating process includes providing a predetermined comparative phase shift to adjusting of a moment of an injected at least one combustibles component (or fuel) injection during said burning process or providing a predetermined comparative phase shift to said interior modulating process during said burning process.

The above-mentioned new dynamic energy-saving superconductive flow burning systems, realizing the proposed new modulation principles of the energy optimization of the different flow burning process, will provide the following qualitatively new advantages, for example:
the continuous action of a mechanism of hydrodynamic instability progress of the elementary fluid particles in the turbulent flow and flame;
the more degree of fuel burning;
the more effective combustion of difficult-to-burn fuels;
the optimal flame turbulence structure corresponding to maximal value of heat emission flux;
the minimization of the flame length;
the minimization of the fuel consuming;
the significant minimization of CO and Noₓ emissions;
the decrease of length of the burner liner;
the decrease of sizes of the burning chamber; etc.

Said factors predetermine more efficiency of the energetic and exploitation characteristics of new dynamic energy-saving superconductive flow burning systems, which will allow revolutionize a wide range of applications in the numerous flow industrial fields. Furthermore, the possibility of development of various compact modern dynamic components (energy-saving dynamic modules) also allows re-equipping with them the existing flow burning systems as well as to utilize them in newly developed dynamic flow burning systems.

The examples of use of new development dynamic energy-saving superconductive flow burning systems covered, without any limitation, for example: cracking, coking, blast, reforming, gas, glass furnaces; heater processes for petroleum refining and petrol-chemical industries; aviation and rocket systems (turboreactive and reactive engines); steam generation processes for production of power and electricity; dosed special destination systems (example, plasma systems for dusting different materials, aero- and hydro-acoustic generators); boiler and domestic heater systems; and etc.

The interesting example of similar dynamic systems can be, without any limitation, the different various systems of dynamic energy-saving superconductive flow internal combustion engine, which based on the realization of the above-mentioned new proposed modulation method. These new dynamic systems realizing the complex of two energy optimization tasks: the above-mentioned dynamic medium flow pipeline transporting and dynamic medium flow spatial structure in a combustion chamber of a engine cylinder block (outside flow pipeline zone). The known similar flow internal combustion engine system comprise, for example, at least one a means of injected fuel flow-forming energy action (pump); at least one a suction pipeline and at least one a power pipeline for transporting of said fuel flow; at least one a cylinder block including at least one a fuel injection valve for adjusting a moment, a duration and a law of a fuel injection into at least one a combustion chamber of said cylinder block with at least one a movable piston; and a energize element for adjusting a energetically parameters, a moment, a duration and a law of a injected fuel ignition into said combustion chamber. Herewith, the above-mentioned method of dynamic energy optimizing of said flow process (realizing for example, by use of at least one the above-mentioned energy-saving dynamic module) can comprise the modulating a value of at least one said fuel flow-forming energy action of at least one said means and also—above-mentioned optimization changing a value of at least one a parameter of said modulating in dependence on a change of a value of at least one a technological characteristic connected with a process of energy converting realizable in said combustion chamber of engine cylinder block, for dynamic space-temporal structure-energetically optimization, in a energy-effective manner, of said energy converting process.

In the process of realization of the new dynamic method of energy optimizing in the above-mentioned dynamic energy-saving superconductive flow internal combustion engine systems can be used said technological characteristic connected with the energy efficiency of said flow energy converting process and selected from the group consisting of (without any limitation): a energy consumption of said means of injected fuel flow-forming energy action (a pump energy consumption); a power, a temperature and a rate of said injected fuel flow; a temperature into said combustion chamber; said moment, said duration and said law of said fuel injection; said energetically parameters, said moment, said duration and said law of said injected fuel ignition; a velocity of said movable piston; a physical and/or chemical parameters of a exhaust combustion products (mostly, for example, a carbon dioxide, toxic gases and water); etc.

In these cases of the realization of the method of energy optimizing, for example, the modulated fuel flow periodic injection (in said combustion chamber of engine cylinder block) process is the independent predetermined periodic process, which constructive connected with the modulated pipeline fuel flow. The other independent predetermined periodic process, which constructive connected with the modulated pipeline fuel flow, can come on the periodic injected fuel ignition process. Herewith, said three dynamic processes includes providing a predetermined comparative phase shifts between a predetermined phases of said pipeline fuel flow modulating, said modulated fuel flow periodic injection and said periodic injected fuel ignition, accordingly, which can changing by a change of the phase of said modulating during said fuel flow energy converting process in dependence on a change of value at least one of above-mentioned characteristic. Said change of the phase of said modulating provides a predetermined comparative phase shift to adjusting of said fuel injection moment and said fuel ignition moment, simultaneous with fuel flow longitudinal plane “drop-shaped” form waves of modulated flow-forming energy action. The possibility of optimization control of said predetermined comparative phase shifts allows to set and to maintain in the average (during the modulation period Tₘ) of the dynamic superconductive energy-effective state of fuel flow spatial structure in said combustion chamber of engine cylinder block.

Besides, said changing a value of at least one a parameter of said negative modulating (with the use of the proposed phase automatic control, medium flow longitudinal plane “drop-shaped” form waves of modulated flow-forming energy action and energy optimizing criterion) includes providing a regime of a maximal value of velocity of said movable piston and a minimal value of a fuel consumption of said internal combustion engine during said fuel flow energy converting process, simultaneous—superconductive energy regime. Herewith, fuel flow longitudinal plane “drop-shaped” form waves of modulated flow-forming energy actions, spreading through said flow internal combustion engine system (said fuel flow pipelines and said fuel flow combustion chamber of engine cylinder block) providing a structure-energetically ‘resonance’ respond of the all medium structure action object by optimization of the dynamic parameters of said fuel flow modulation. Herewith, during the process of compressing of a volume of modulated flow fuel in said burning chamber the elementary particles of fuel mixture are being disrupted almost until the molecular level. The intensity of particles turbulent chaotically movement significantly increases, that lead to increase of a mixing intensity and providing a uniform mixture distribution (and as a consequence—significantly decrease of a distributed mixture volume viscosity) to the all volume of said burning chamber. These lead to the significantly decrease of a time of preparation of combustible mixture during said compressing process and providing of a favorable conditions to minimize of a injected portion burning time during said burning process. Said structure-energetically ‘resonance’ respond of turbulent structure and geometry of a dynamic space-temporal injected fuel burning working zone into said combustion chamber of internal combustion engine will provide, in a energy-effective high temperature-velocity manner, maximal velocity and maximal full of said injected fuel flow chamber combustion covered all the phases of a fire (includes a laminar and turbulent burning).

In the different cases of the realization of the method of energy optimizing said modulating can include the co-called exterior modulating process, which realize a principle of controlled exterior dynamic shunting of a selected portion of said fuel flow suction pipeline, and provide a modulating connection a suction pipeline interior cavity with at least one a injected fuel mix components, simultaneously to optimize a dosage and a dynamic space-temporal mixing of different said combustibles components and said transporting fuel flow in said fuel flow suction and power pipelines.

The above-mentioned factors predetermine more efficiency of the energetic, exploitation and ecological characteristics of new dynamic energy-saving superconductive flow internal combustion engine systems, which will allow revolutionize a wide range of applications in the numerous industrial fields.

The other interesting demonstrative examples of new development dynamic energy-saving superconductive medium flow technological systems include three following wide classification groups of the new class of different similar energy-saving systems, without any limitation, for example:
the dynamic so-called “structurally connected” turbine, turbo-reactive or reactive engines for different high speed apparatuses (aircrafts, helicopters, rockets, reactive cars, sport cars, boats, ships, submarines and etc.), or the dynamic “structurally connected” systems of engines for space apparatuses of special usage, which provide the dynamic energy-saving superconductive medium flow transporting of object in said dynamic “structurally connected” system;
the dynamic so-called “surface-energy” systems, which structurally realize the principle so-called “breathing surfaces” on structural part corpuses of said different high speed apparatuses, or the dynamic “surface-energy” systems, which structurally realize the principle aero- or hydrodynamic surface-distributed controlled so-called “dynamic rudders” on the wages or empennage of said different high speed apparatuses, for provide the dynamic “supereffective” aero- or hydrodynamic characteristics of said dynamic “surface-energy” systems; and also
the different dynamic energy-saving superconductive “explosive” systems, which realize the “supereffective” aero- or hydrodynamic characteristics of dynamic medium flow action (spatial, barrel or special) on the object, as disclosed for example in U.S. Pat. No. 6,827,528 (2004)—A. Relin.

In these cases of the realization of the method of energy optimizing the above-mentioned independent predetermined periodic processes can include practically all the above-mentioned variants (directly connected with said general modulated medium flow; connected with said general modulated medium flow across at least one a medium flow action working zone including at least one a medium flow action object; connected with said general modulated medium flow, which constructive separated from said modulated medium flow periodic process; said periodic process is a periodic injection of said modulated medium flow inside at least one a working zone; said periodic process is a periodic energy action on said modulated medium flow, which injected inside at least one a working zone for a realization of energy converting process; etc.) and also—the specific variants, without any limitation, for example:
providing a modulating a value of a medium flow-forming energy action of at least one an additional means of medium flow-forming energy action connected with an additional modulated medium flow, which constructive separated from said general modulated medium flow (for example, in the above-mentioned different high speed or space apparatuses with at least two the dynamic so-called “structurally connected” turbine, turbo-reactive or reactive engines); or/and
providing a modulating a value of a medium flow-forming energy action of at least one a additional means of a medium flow-forming energy action connected with an additional modulated medium flow, which constructive directly not connected with said general modulated medium flow (for example, in the above-mentioned dynamic energy-saving superconductive “explosive” system including at least two a constructive directly not connected between them similar dynamic “explosive” subsystems, which realize the “supereffective” dynamic medium flow spatial actions on the object, simultaneously).

Herewith, said dynamic processes include providing a predetermined comparative phase shift between a predetermined phases of said general flow modulating and at least one said additional periodic process, which can be changed by the changes of phase of said modulating in dependence on a change of value at least one of technological characteristic during either above-mentioned realizable dynamic process. The possibility of optimization control of said predetermined comparative phase shift (with the use of proposed medium flow longitudinal plane “drop-shaped” form waves of modulated flow-forming energy action and energy optimizing criterion) allows, for example, to set and to maintain in the average (during the modulation period Tₘ) of the dynamic superconductive energy-effective state of said realizable dynamic process (accompanied of the dramatic decrease of aero- or hydrodynamic resistance of realizable modulated flows) or to provide the dynamic synchronization of a work of “structurally connected” turbo-reactive engines in the above-mentioned different high speed apparatuses.

The above-mentioned fundamentally new possibilities predetermine more efficiency of the energetic, exploitation and ecological characteristics of new similar dynamic energy-saving superconductive systems, which also will allow revolutionize a wide range of applications in the numerous industrial fields.

At the same time, the proposed dynamic energy-saving superconductive method can be efficiently realized not only in these systems, which use as the flow-forming energy action means acting on the carrying medium, the above-mentioned types of pressure drop means. The inventive method can be efficiently realized in “energy” systems, which use as the means of action on the carrying medium—a means of direct energy action (magneto-hydrodynamic pumps, magnetic and electromagnetic accelerating systems, etc.). In such flow-forming energy action means the energy supplied to them (or several types of energy) is converted directly into a direct energy action on the carrying medium for creating its flow. As the supplied energy it is possible to use for example: electrical, electromagnetic, magnetic, etc. energy, or a combination of several types of energy (for example a combination of magnetic and electrical energy as in a magneto-hydrodynamic pumps).

In these “energy” systems the modulation of the value of the flow-forming energy action in the means of direct energy action (with the use of proposed phase automatic control, medium flow longitudinal plane “drop-shaped” form waves of modulated flow-forming energy action and energy optimizing criterion) can be performed by providing of the controlled predetermined dynamic periodic changes of a value of at least one a parameter, dynamically connected with a process of a conversion of a consumption energy to said modulated medium flow-forming energy action realizable in said means of medium flow-forming direct energy action, as disclosed for example in U.S. Pat. No. 6,827,528 (2004)—A. Relin.

For example in a magneto-hydrodynamic pump, as the changing conversion parameter it is possible to use: an induction of a magnetic field or an electrical voltage, applied to a portion of the carrying medium flow; an additional resistance introduced into an electrical circuit in series with the above-mentioned portion of the carrying medium flow; etc. In this case for realization of the inventive dynamic energy-saving superconductive method, the magneto-hydrodynamic pump must be additionally equipped with a special “parametric energy-saving dynamic module” for the given dynamic periodic changes of the value of the selected above-mentioned at least one conversion parameter.

In such “energy” systems, the optimization of control of the modulation is also connected with the use of some of the controlled characteristics, which reflect the process of transporting of the object with the flow of carrying medium. These systems can include various “beam” systems of conversion of energy; gas flow systems with the use of a magneto-hydrodynamic generator; etc. The efficiency of use in such “energy” systems of the proposed inventive method can be connected with the increase of the converted (into other type) energy, and also with the increase of parameters characterizing its quality. The latter is determined by a possibility of minimization of influence on the process of conversion of turbulent factors and also—the dynamic nature of movement of the modulated medium flow particles.

At the same time, this approach to provide the modulation of the use of various types of the special “parametric energy-saving dynamic module” can be efficiently used in some of the above-mentioned systems, which have the pressure drop means as the medium flow-forming energy action means. In this case as the changing conversion parameter it is possible to use, for example: electrical, electromagnetic, magnetic, technical, physical, chemical, physical-chemical parameters or a combination of several of these or other parameters. The parameter (parameters) can be selected with the consideration of the type of the supplied energy and the principle of action of the pressure drop means. This can be a functionally-structural or energy conversion parameter, which is connected dynamically with the process of conversion of the supplied energy into the medium flow-forming energy action and significantly directly acting on the process of conversion with its given change. The function of the “parametric energy-saving dynamic module” can be realized in the various variants of dynamic control devices, which provide the possibility of the given dynamic periodic change of the value of the selected “modulated” conversion parameter, for example with the use of dynamic electromagnetic coupling, on the basis of special modulators of “position” of functional structural elements of the action means; or—the special modulators of its main energy parameters; etc. Therefore, the above-mentioned approach with the use of various types of the special devices of “parametric energy-saving dynamic module” as a methodological solution in performing of the modulation of the value of the medium flow-forming energy action, can be used also in various action means for the realization of the new proposed dynamic energy-saving superconductive medium flow transporting “energy” systems.

The above-mentioned analysis of all examples of possible efficient use of the proposed energy-saving superconductive optimization method persuasively illustrates the common most characteristic decisive and distinctive features of the present invention. In turn the above-mentioned advantages of the proposed inventive method open wide possibilities to create a principally new class of energy-saving superconductive dynamically controlled medium flow transporting systems, which provide efficient energy and exploitation characteristics of various processes of medium flow transporting. This reflects the possibility of a transition of the traditional processes of medium flow transporting to a qualitatively new step of their development. This step of development will be characterized by a wide use of the dynamic energy-saving superconductive medium flow transporting technologies, connected with the new above-mentioned dynamic flow-forming energy actions on the carrying medium, and also—with dynamic, multi-parameter optimization control, which uses a current control of dynamic technological characteristics of such processes of dynamic transporting of various objects by a dynamic created flow of carrying medium.

The dimensions and produce cost of the energy-saving dynamic modules (in the above-mentioned cases) will not exceed a small part (twenty-thirty percentages) of the dimensions and total price of the corresponding pumping systems consisting of the pump, the drive and the controlling block. The energy-saving dynamic modules (realize said above-mentioned negative optimization modulating with the use of proposed phase automatic control, medium flow longitudinal plane “drop-shaped” form waves of modulated flow-forming energy action and energy optimizing criterion) can be designed and produced in a various types of constructive shapes depending on a power of the pumps or pumping systems, a pipeline transporting structure (length, diameter, pressure, flow capacity, etc.), the different flow media and using different functional modifications (for one-parametric or multi-parametric optimization of dynamic process). Besides, it should be noted that, a inlet of the longer inlet portion of a module shunt channel 6 (see, for example, FIG. 2) can be dynamic protected by an additional filtering element (are described in detail, for example in the above-mentioned our U.S. patent). Future amount of the energy-saving dynamic modules to be manufactured may reach millions of pieces for the existing and new class of various medium flow pipeline transporting systems. Therefore, the potential entire market for the energy-saving dynamic module and new dynamic systems may be estimated at multi-billion dollar level.

In the future, parallel with the development and manufacturing of the energy-saving dynamic modules, the in principle new dynamic microprocessor means (or systems) of the flow-forming energy action—the energy-saving dynamic pumps (as dynamic controlled “generator” of the flow-forming energy actions on the carrying medium flow), will be created. Such energy-saving dynamic pumps will include the new constructive conjugation between the means of flow-forming energy action (for example, pump) and all listed-above basic functional components of the energy-saving dynamic module. Similar energy-saving dynamic pumps can also be created in the kind of different functional modifications (for instance, for one-parametric or multi-parametric controlling), and also—for different parameters of pipelines and flow of carrying medium. Needs for similar energy-saving dynamic pumps will be predefined by a volume of introduced on exploitation of the new different dynamic energy-saving superconductive medium flow transporting systems, and also—by a possible volume of changing the old pumps to the new energy-saving dynamic pumps in the exploited medium flow pipeline transporting systems. The needed amount in the future of said manufacturing of the energy-saving dynamic pumps may also reach millions of units and their total market price—billions of dollars.

At the same time, the new above-mentioned energy-saving dynamic module (connected with pump) and the energy-saving dynamic pump additionally can provide the function of dynamic controlled pipeline “valve”. Said function can provides, for example, the given change of position of the above-mentioned control element 23 in the cylindrical valve block of the energy-saving dynamic module 5, predetermined given change of a value of the pipeline medium flow rate by the given “shunting” change of the pump pressure value. The similar function of the dynamic controlled pipeline “valve” allow the change of said pipeline medium flow rate without the additionally change of the working pipeline cross-section, that provide an extra decrease of pump energy consumption.

Therefore, discovered creation by authors (in Remco International, Inc., PA, USA) of the above-mentioned new energy optimization design principles of the development of the energy-saving dynamic module and the energy-saving dynamic pumps for realization of the different dynamic energy-saving superconductive medium flow transporting technologies will form on the market in principle new class of the various modern intellegence dynamic energy-saving products, which have not analogs on the world market. One of the very important advantages in applying the similar dynamic energy-saving technologies is that all exploited pipelines and pump systems don't change. It's sufficient only to adjust the energy-saving dynamic module to the exploited pump in the existing medium flow transporting system.

The development above-mentioned new dynamic energy-saving superconductive medium flow transporting technologies, which realize the above-mentioned energy hydrodynamic superconductivity phenomenon, can be compared with the possible application of electric superconductivity phenomenon, from the energy-saving point of view. During 100 years since it was discovered, there were spent billions of dollars for carrying out the experimental and theoretical researches. But until present time, this phenomenon doesn't have wide practical applications, because the accessible superconductors have not yet been created. Moreover, even if such superconductors will create (may be during the near fifty years), it will be necessary to change the electro conductors to the new superconductors in all the networks and equipments (such as, generators, motors and transformers, and others). As a result of this possible very expensive and long-term changing the electro conductors to the new superconductors the electric energy economy can be consist no more than five percentages of all world energy market. At the same time, the implementation of the development above-mentioned new dynamic energy-saving superconductive medium flow transporting technologies can starting during relatively three years and is practically without alternative energy-saving technologies for the all energy world market. All these will be accompanied by minimum cost for further development and subsequent implementation of new unique break-through dynamic energy-saving technologies with maximum preservation of already existing large energy consumption technological infrastructures, which cover up to seventy percentages of the world's industries.

Besides, the new dynamic energy-saving superconductive medium flow transporting technologies guarantees a decrease in electrical energy consumption by billions kilowatt-hours per year. Taking into consideration that the energy capacity quota of similar technologies is higher than fifty percentages of energy consumption world market, the economy of energy and energy resources can reach about thirty percentages of all world energy market, and their total market price—hundreds of billions of dollars. Said advantages will predetermine considerable decrease (at two-three times) the specific price of dynamic energy-saving flow transporting the different materials and media, and also—have an significant influence on the decrease of a prices of a energy resources and an industrial products.

Realization of the developed revolutionary dynamic energy-saving superconductive medium flow transporting technologies will allow open wide possibilities to create a principally new class of industrial dynamically controlled systems, which provide efficient energy and exploitation characteristics of various processes of transporting of object with flow of carrying medium. This brings the possibility to have the transition of traditional industrial processes of transporting to a qualitatively new step of their development. In fact, these technologies may become the standard for different industries in the twenty firs century and will mark a new era of the technical evolution in energy-saving transporting technologies, based on the superconductivity of medium flows. As result of this conversion, a tremendous saving of energy resources, new technological, exploitative, quality and price-forming possibilities for various applications on the multi-billion dollar market across the globe, can be achieved. In addition, this also determines the possibility of obtaining a multi-billion dollar economic effect connected with the solution of known general energy, humanitarian, ecological and social world problems.

It will be understood that each of the elements described above, or two or more together, may also find a useful application in other types of methods and devices differing from the types described above.

While the invention has been illustrated and described as embodied in the new method of dynamic energy-saving superconductive transporting of medium flow, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed as new and desired to be protected by Letters Patent is set forth in the appended claims.

1. In a transporting system comprising at least one a means of medium flow-forming energy action for providing a dynamic energy-saving superconductive medium flow process, a method of energy optimizing includes a negative modulating of said energy action with predetermined law, predetermined range and predetermined frequency of said modulating is changed to provide a plane form of a modulated energy action flow longitudinal waves, wherein said law of negative modulating a value of said medium flow-forming energy action is a predetermined “drop-shaped” form selected, and said modulating includes a comparative phase when said modulated medium flow related with at least one an independent predetermined periodic process; and providing a minimal value of energy ratio of a controlled in action value of said modulated medium flow-forming energy into a controlled in action value of a formed kinetic energy of said modulated medium flow during said dynamic medium flow process by changing a value of at least one said modulation parameter in dependence on a change of a value of at least one a characteristic connected with said dynamic medium flow process to dynamic structure-energetically optimize, in an energy-effective manner, said dynamic medium flow process.

2. A method of energy optimizing as defined in claim 1, wherein said predetermined “drop-shaped” form of said law of said negative modulating includes providing decrease of a value of said medium flow-forming energy action from a current maximal value on a predetermined value of range of said modulating during a predetermined front time of realizing a predetermined front short part of said “drop-shaped” form of said law, and providing recovery of a value of said medium flow-forming energy action until said current maximal value during a predetermined back time of realizing a predetermined back extended part of said “drop-shaped” form of said law during an each predetermined period of said negative modulating is changed to provide a predetermined period and frequency of said modulating.

3. A method of energy optimizing as defined in claim 2, wherein said predetermined front short part of “drop-shaped” form of said modulation law is changed a form of a predetermined quarter ellipse curve such that a horizontal axis of said ellipse coincided with a horizontal axis of said “drop-shaped” form of said modulation law, and said predetermined back extended part of “drop-shaped” form of said modulation law is changed a form of a predetermined degree function curve such that an initial value of said degree function curve coincides with an ending value of said quarter ellipse curve.

4. A method of energy optimizing as defined in claim 2, wherein said predetermined “drop-shaped” form of said law of said negative modulating includes providing a predetermined value of time ratio of said predetermined front time into said predetermined period of said negative modulating, which is selected from the range: more than 0 and less than 0.5.

5. A method of energy optimizing as defined in claim 4, wherein said value of time ratio is an additional predetermined modulation parameter of said negative modulating, changeable in dependence on a change of a value of at least one a characteristic connected with said dynamic medium flow process to provide a minimal value of energy ratio of a controlled in action value of said modulated medium flow-forming energy into a controlled in action value of a form kinetic energy of said modulated medium flow during said dynamic medium flow process for dynamic structure-energetically optimization, in an energy-effective manner, of said process.

6. A method of energy optimizing as defined in claim 5, wherein said change of said value of time ratio includes changing a predetermined front time and providing a predetermined period of said negative modulating simultaneously.

7. A method of energy optimizing as defined in claim 5, wherein said change of said value of time ratio includes changing a predetermined period of said negative modulating and providing a predetermined front time simultaneously.

8. A method of energy optimizing as defined in claim 5, wherein said change of said value of time ratio includes changing a predetermined front time and a predetermined period of said negative modulating simultaneously.

9. A method of energy optimizing as defined in claim 1, wherein said negative modulating comprises a modulation discrete input.

10. A method of energy optimizing as defined in claim 1, wherein said negative modulating comprises an optimization parametric input.

11. A method of energy optimizing as defined in claim 1, wherein said independent predetermined periodic process includes providing a frequency, a range, a law and a comparative phase of a predetermined periodic parametric changes.

12. A method of energy optimizing as defined in claim 1, wherein modulated medium flow includes providing a predetermined comparative phase of a negative modulating is changed to provide a predetermined phase shift to a comparative phase of said independent predetermined periodic process.

13. A method of energy optimizing as defined in claim 1, wherein said independent predetermined periodic process includes providing a modulating a value of a medium flow-forming energy action of at least one an additional means of medium flow-forming energy action directly connected with said modulated medium flow.

14. A method of energy optimizing as defined in claim 1, wherein said independent predetermined periodic process includes providing a modulating a value of a medium flow-forming energy action of at least one an additional means of medium flow-forming energy action connected with said modulated medium flow across at least one a medium flow action working zone including at least one a medium flow action object.

15. A method of energy optimizing as defined in claim 14, wherein said medium flow action working zone includes at least one a perforating admission to provide of a perforated medium flows.

16. A method of energy optimizing as defined in claim 14, wherein said medium flow action object is a porous structure object.

17. A method of energy optimizing as defined in claim 14, wherein said medium flow action object is a filter structure object.

18. A method of energy optimizing as defined in claim 14, wherein said medium flow action object is a porous medium saturated object.

19. A method of energy optimizing as defined in claim 14, wherein said medium flow action object is a constructive structure object.

20. A method of energy optimizing as defined in claim 14, wherein said medium flow action object is a specific detection object.

21. A method of energy optimizing as defined in claim 1, wherein said independent predetermined periodic process includes providing a predetermined periodic injection said modulated medium flow inside at least one a working zone.

22. A method of energy optimizing as defined in claim 1, wherein said independent predetermined periodic process includes providing a predetermined periodic injection said modulated medium flow inside at least one a working zone for a realization of a technological process in said working zone including at least one a medium flow action object.

23. A method of energy optimizing as defined in claim 1, wherein said independent predetermined periodic process includes providing a predetermined periodic energy action on said modulated medium flow injected inside at least one a working zone for a realization of a process of energy converting of said modulated medium flow in said working zone.

24. A method of energy optimizing as defined in claim 23, wherein said working zone is an injected modulated medium flow burning zone.

25. A method of energy optimizing as defined in claim 23, wherein said working zone is an injected modulated fuel flow burning zone into a combustion chamber of internal combustion engine.

26. A method of energy optimizing as defined in claim 1, wherein said independent predetermined periodic process includes providing a modulating a value of a medium flow-forming energy action of at least one an additional means of medium flow-forming energy action connected with an additional modulated medium flow, which constructive separated from said general modulated medium flow.

27. A method of energy optimizing as defined in claim 26, wherein said constructive separated additional modulated medium flow and said modulated medium flow is predetermined simultaneously to provide a heat-transferring process into a “double-canal” heat exchanger.

28. A method of energy optimizing as defined in claim 26, wherein said constructive separated additional modulated medium flow and said modulated medium flow is predetermined simultaneously to provide a movement process of at least one an object constructive connected with said modulated medium flows.

29. A method of energy optimizing as defined in claim 1, wherein said independent predetermined periodic process includes providing a modulating a value of a medium flow-forming energy action of at least one an additional means of medium flow-forming energy action connected with an additional modulated medium flow, which constructive directly is not connected with said modulated medium flow.

30. A method of energy optimizing as defined in claim 1, wherein said providing said minimal value of energy ratio look toward provide of a minimal value up to equal one for keep up a superconductive energy regime of said modulated medium flow transporting.

31. A method of energy optimizing as defined in claim 1, wherein said controlled in action value of said modulated medium flow-forming energy is evaluated by use of a controlled in action value of a modulated medium flow pressure, providing of said means of medium flow-forming energy action.

32. A method of energy optimizing as defined in claim 1, wherein said controlled in action value of said modulated medium flow-forming energy is evaluated by use of a controlled in action value of at least one a energy parameter, connected with a value of energy consumption of said means of medium flow-forming energy action.

33. A method of energy optimizing as defined in claim 1, wherein said controlled in action value of said formed kinetic energy of said modulated medium flow is evaluated by use of a controlled in action value of a modulated medium flow velocity and a predetermined value of a flow medium density.

34. A method of energy optimizing as defined in claim 1, wherein said controlled in action value of said formed kinetic energy of said modulated medium flow is evaluated by use of a controlled in action value of a modulated medium flow velocity and a controlled in action value of a flow medium density.

35. A method of energy optimizing as defined in claim 1, wherein said negative modulating a value of said medium flow-forming energy action includes providing an interior modulating process, which realizes the principle of a controlled interior dynamic shunting of a suction and a power working zones of said means of medium flow-forming energy action.

36. A method of energy optimizing as defined in claim 1, wherein said negative modulating a value of said medium flow-forming energy action includes providing an exterior modulating process, which realizes the principle of controlled exterior dynamic shunting of a selected portion of a modulated suction medium flow, connected with a suction working zones of said means of medium flow-forming energy action.

37. A method of energy optimizing as defined in claim 1, wherein said negative modulating a value of said medium flow-forming energy action includes providing an interior modulating process, which realizes the principle of a controlled interior dynamic shunting of a suction and a power working zones of said means of medium flow-forming energy action; and an exterior modulating process, which realize the principle of controlled exterior dynamic shunting of a selected portion of a modulated suction medium flow, connected with a suction working zones of said means of medium flow-forming energy action; simultaneously.

38. A method of energy optimizing as defined in claim 1, wherein said negative modulating a value of said medium flow-forming energy action includes providing a controlled predetermined dynamic periodic changes of a value of at least one a parameter, dynamically connected with a process of a conversion of a consumption energy to said modulated medium flow-forming energy action realizable in said means of medium flow-forming energy action.

39. A method of energy optimizing as defined in claims 35, 36, 37, wherein said dynamic shunting includes providing a controlled predetermined dynamic periodic connection of said modulated suction medium flow with modulated shunt medium flow, realizing around of said modulated suction medium flow.

40. In a transporting system comprising at least one a means of medium flow-forming energy action for providing a dynamic energy-saving superconductive medium flow process, a method of energy optimizing includes a negative modulating of said energy action with a predetermined law, a predetermined range and a predetermined frequency of said modulating is changed to provide a plane form of a modulated energy action flow longitudinal waves, wherein said modulating includes a comparative phase is changed to provide a phase shift to a comparative phase of an independent periodic process related with the modulated flow; and optimized changing a value of at least one a modulation parameter in dependence on a change of a value of at least one a characteristic connected with said medium flow process to dynamic structure-energetically optimize, in an energy-effective manner, of said dynamic medium flow process.

41. A method of energy optimizing as defined in claim 40, wherein said law of modulating is a predetermined “drop-shaped” form selected, and provides:
decrease of a value of said medium flow-forming energy action from a current maximal value on a predetermined value of said range of modulating during a predetermined front time of realizing a predetermined front short part of said “drop-shaped” form of said law during an each predetermined period of said negative modulating, which is changed a form of a predetermined quarter ellipse curve such that a horizontal axis of said ellipse coincided with a horizontal axis of said “drop-shaped” form of said modulation law;
recovery of a value of said medium flow-forming energy action until said current maximal value during a predetermined back time of realizing a predetermined back extended part of said “drop-shaped” form of said law during an each predetermined period of said negative modulating, which is changed a form of a predetermined degree function curve such that an initial value of said degree function curve coincides with an ending value of said quarter ellipse curve to provide a predetermined period of said modulating;
predetermined value of time ratio of said predetermined front time into said predetermined period of said negative modulating, which is an additional predetermined modulation parameter of said negative modulating and is selected from the range: more than 0 and less than 0.5.

42. A method of energy optimizing as defined in claim 40, wherein said dynamic structure-energetically optimization includes providing a minimal value of energy ratio of a controlled in action value of said modulated medium flow-forming energy into a controlled in action value of a formed kinetic energy of said modulated medium flow during said dynamic medium flow process.
